(19) United States
(12) Patent Application Publication
(10) Pub. No.: US 2018/0121252 A1
(43) Pub. Date: May 3, 2018

(54) System And Method For Providing Persistence In A Configurable Platform Instance

(71) Applicant: SOCIETAL INNOVATIONS IPCO LIMITED, London (GB)

(72) Inventors: Douglas A. Standley, Boulder, CO (US); Matthew R. Dodge, Dana Point, CA (US); Randall E. Bye, Louisville, CO (US)

(21) Appl. No.: 15/829,192

(22) PCT Filed: Jun. 1, 2016
(86) PCT No.: PCT/IB2016/000839

§ 371 Date: Dec. 1, 2017

Related U.S. Application Data
(60) Provisional application No. 62/169,915, filed on Jun. 2, 2015.

(51) Int. Cl. G06F 9/50; G06F 9/46

(52) U.S. Cl. CPC G06F 9/5083; G06F 9/466

(57) ABSTRACT

An improved system and method are disclosed for providing persistence for components of a configurable neutral input/output (NIO) platform. For example, a block running with a service of the NIO platform may be configured to write information to and retrieve information from a persistence storage either directly or using an intermediary, such as a persistence module. The persistence of information enables the block to restart and resume running using a previous saved state.

### CROSS-REFERENCE TO RELATED APPLICATIONS

This application is a Patent Cooperation Treaty Application of U.S. Provisional Application No. 62/169,915, filed Jun. 2, 2015, entitled SYSTEM AND METHOD FOR PROVIDING PERSISTENCE IN A CONFIGURABLE PLATFORM INSTANCE (Atty. Dkt. No. SNVS-32649), which is incorporated by reference herein in its entirety. This application also incorporates PCT/IB2015/001288, filed on May 21, 2015, by reference in its entirety.

### BACKGROUND

The proliferation of devices has resulted in the production of a tremendous amount of data that is continuously increasing. Current processing methods are unsuitable for processing this data. Accordingly, what is needed are systems and methods that address this issue.

### BRIEF DESCRIPTION OF THE DRAWINGS

For a more complete understanding, reference is now made to the following description taken in conjunction with the accompanying Drawings in which:

FIG. 1A illustrates one embodiment of a neutral input/output (NIO) platform with customizable and configurable processing functionality and configurable support functionality;

FIG. 1B illustrates one embodiment of a data path that may exist within a NIO platform instance based on the NIO platform of FIG. 1A;

FIGS. 1C and 1D illustrate embodiments of the NIO platform of FIG. 1A as part of a stack;

FIG. 1E illustrates one embodiment of a system on which the NIO platform of FIG. 1 A may be run;

FIG. 2 illustrates a more detailed embodiment of the NIO platform of FIG. 1A;

FIG. 3A illustrates another embodiment of the NIO platform of FIG. 2;

FIG. 3B illustrates one embodiment of a NIO platform instance based on the NIO platform of FIG. 3A;

FIGS. 4A and 4B illustrate another embodiment of the NIO platform of FIG. 2 from a platform perspective and a stack perspective, respectively;

FIG. 4C illustrates one embodiment of a service that may exist within the NIO platform of FIGS. 4A and 4B;

FIG. 5 illustrates one embodiment of the interaction between various components within the NIO platform of FIGS. 4A and 4B;

FIG. 6 illustrates one embodiment of a workflow that may be used to create and configure a NIO platform;

FIG. 7 illustrates one embodiment of the NIO platform of FIG. 6;

FIG. 8 illustrates one embodiment of a component configuration environment within which a component is configured at runtime using only predefined configuration information;

FIG. 9 illustrates one embodiment of a component configuration environment within which a component is configured at runtime using a context;

FIG. 10 illustrates one embodiment of a service that may be used within the NIO platform of FIG. 7;

FIGS. 11-13 illustrate embodiments of methods that may be executed by the NIO platform of FIG. 7 to configure components using contexts;

FIGS. 14-20 illustrate embodiments of sequence diagrams that show communications between various components of the NIO platform of FIG. 6 that may occur in order to store and/or retrieve persistence information; and

FIGS. 21-25 illustrate embodiments of methods that may be executed within the NIO platform of FIG. 6 in order to store and/or retrieve persistence information.

### DETAILED DESCRIPTION

The present disclosure is directed to a system and method for providing persistence in a neutral input/output platform instance. It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The present disclosure describes various embodiments of a neutral input/output (NIO) platform that includes a core that supports one or more services. While the platform itself may technically be viewed as an executable application in some embodiments, the core may be thought of as an application engine that runs task specific applications called services. The services are constructed using defined templates that are recognized by the core, although the templates can be customized to a certain extent. The core is designed to manage and support the services, and the services in turn manage blocks that provide processing functionality to their respective service. Due to the structure and flexibility of the runtime environment provided by the NIO platform's core, services, and blocks, the platform is able to asynchronously process any input signal from one or more sources in real time.

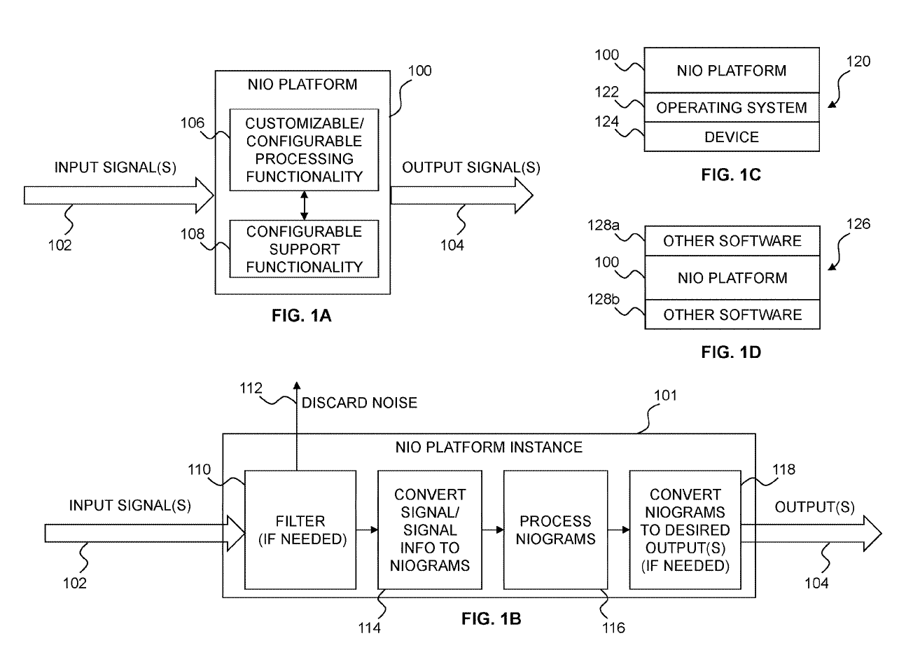

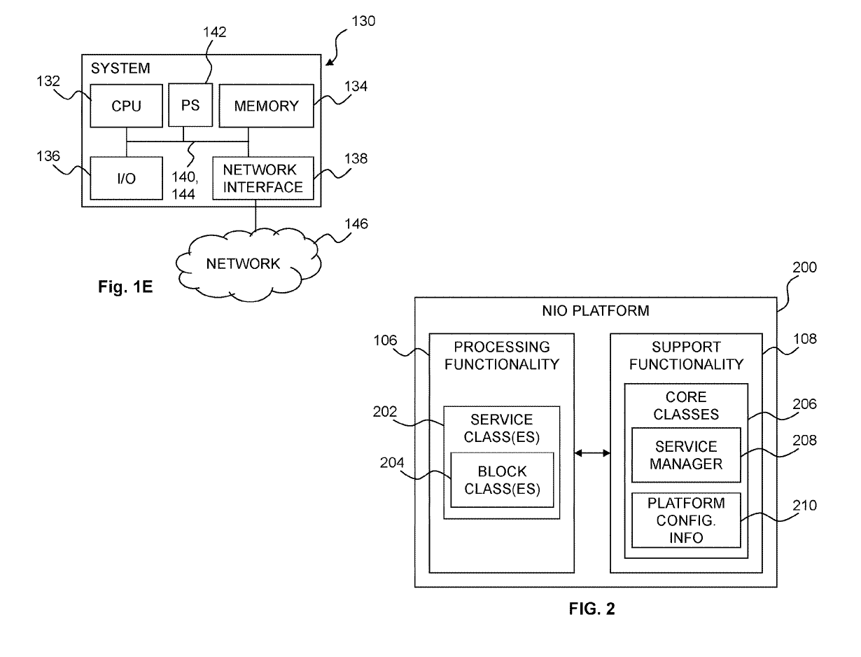

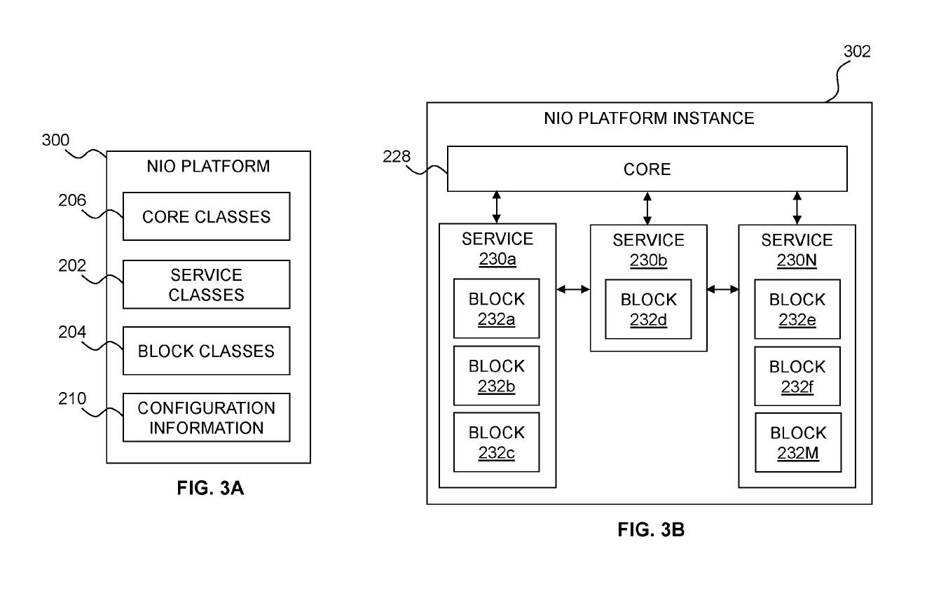

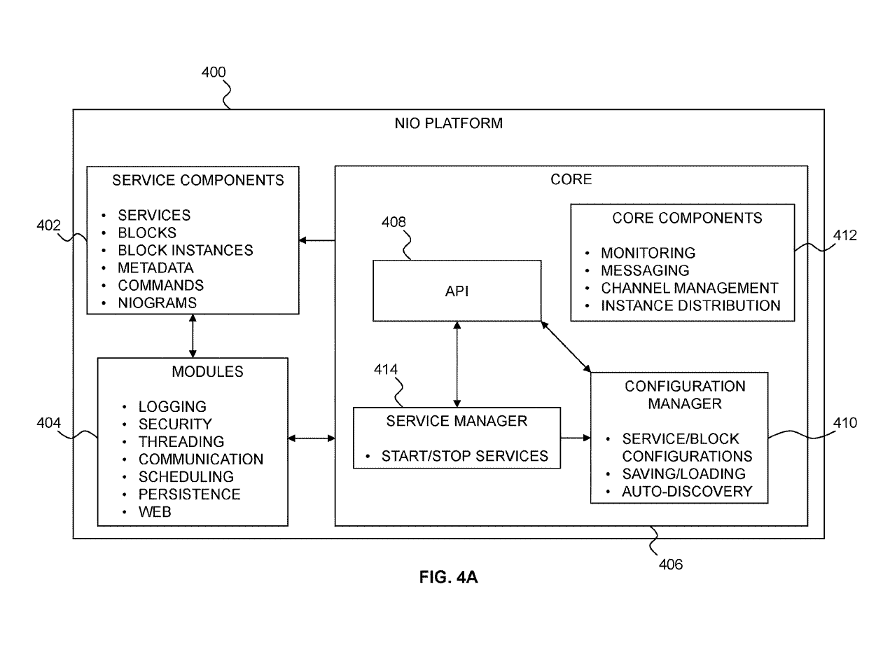

Referring to FIG. 1A, one embodiment of a NIO platform 100 is illustrated. The NIO platform 100 is configurable to receive any type of signal (including data) as input, process those signals, and produce any type of output. The NIO platform 100 is able to support this process of receiving, processing, and producing in real time or near real time. The input signals can be streaming or any other type of continuous or non-continuous input.

When referring to the NIO platform 100 as performing processing in real time and near real time, it means that there is no storage other than possible queuing between the NIO platform instance's input and output. In other words, only processing time exists between the NIO platform instance's input and output as there is no storage read and write time, even for streaming data entering the NIO platform 100.

It is noted that this means there is no way to recover an original signal that has entered the NIO platform 100 and been processed unless the original signal is part of the output or the NIO platform 100 has been configured to save the original signal. The original signal is received by the NIO platform 100, processed (which may involve changing and/or destroying the original signal), and output is generated. The receipt, processing, and generation of output occurs without any storage other than possible queuing. The original signal is not stored and deleted, it is simply never stored. The original signal generally becomes irrelevant as it is the output based on the original signal that is important, although the output may contain some or all of the original signal. The original signal may be available elsewhere (e.g., at the original signal's source), but it may not be recoverable from the NIO platform 100.

It is understood that the NIO platform 100 can be configured to store the original signal at receipt or during processing, but that is separate from the NIO platform's ability to perform real time and near real time processing. For example, although no long term (e.g., longer than any necessary buffering) memory storage is needed by the NIO platform 100 during real time and near real time processing, storage to and retrieval from memory (e.g., a hard drive, a removable memory, and/or a remote memory) is supported if required for particular applications.

The internal operation of the NIO platform 100 uses a NIO data object (referred to herein as a niogram). Incoming signals 102 are converted into niograms at the edge of the NIO platform 100 and used in intra-platform communications and processing. This allows the NIO platform 100 to handle any type of input signal without needing changes to the platform's core functionality. In embodiments where multiple NIO platforms are deployed, niograms may be used in inter-platform communications.

The use of niograms allows the core functionality of the NIO platform 100 to operate in a standardized manner regardless of the specific type of information contained in the niograms. From a general system perspective, the same core operations are executed in the same way regardless of the input data type. This means that the NIO platform 100 can be optimized for the niogram, which may itself be optimized for a particular type of input for a specific application.

The NIO platform 100 is designed to process niograms in a customizable and configurable manner using processing functionality 106 and support functionality 108. The processing functionality 106 is generally both customizable and configurable by a user. Customizable means that at least a portion of the source code providing the processing functionality 106 can be modified by a user. In other words, the task specific software instructions that determine how an input signal that has been converted into one or more niograms will be processed can be directly accessed at the code level and modified. Configurable means that the processing functionality 106 can be modified by such actions as selecting or deselecting functionality and/or defining values for configuration parameters. These modifications do not require direct access or changes to the underlying source code and may be performed at different times (e.g., before runtime or at runtime) using configuration files, commands issued through an interface, and/or in other defined ways.

The support functionality 108 is generally only configurable by a user, with modifications limited to such actions as selecting or deselecting functionality and/or defining values for configuration parameters. In other embodiments, the support functionality 108 may also be customizable. It is understood that the ability to modify the processing functionality 106 and/or the support functionality 108 may be limited or non-existent in some embodiments.

The support functionality 108 supports the processing functionality 106 by handling general configuration of the NIO platform 100 at runtime and providing management functions for starting and stopping the processing functionality. The resulting niograms can be converted into any signal type(s) for output(s) 104.

Referring to FIG. 1B, one embodiment of a NIO platform instance 101 illustrates a data path that starts when the input signal(s) 102 are received and continues through the generation of the output(s) 104. The NIO platform instance 101 is created when the NIO platform 100 of FIG. 1A is launched. A NIO platform may be referred to herein as a “NIO platform” before being launched and as a “NIO platform instance” after being launched, although the terms may be used interchangeably for the NIO platform after launch. As described above, niograms are used internally by the NIO platform instance 101 along the data path.

In the present example, the input signal(s) 102 may be filtered in block 110 to remove noise, which can include irrelevant data, undesirable characteristics in a signal (e.g., ambient noise or interference), and/or any other unwanted part of an input signal. Filtered noise may be discarded at the edge of the NIO platform instance 101 (as indicated by arrow 112) and not introduced into the more complex processing functionality of the NIO platform instance 101. The filtering may also be used to discard some of the signal's information while keeping other information from the signal. The filtering saves processing time because core functionality of the NIO platform instance 101 can be focused on relevant data having a known structure for post-filtering processing. In embodiments where the entire input signal is processed, such filtering may not occur. In addition to or as alternative to filtering occurring at the edge, filtering may occur inside the NIO platform instance 101 after the signal is converted to a niogram.

Non-discarded signals and/or the remaining signal information are converted into niograms for internal use in block 114 and the niograms are processed in block 116. The niograms may be converted into one or more other formats for the output(s) 104 in block 118, including actions (e.g., actuation signals). In embodiments where niograms are the output, the conversion step of block 118 would not occur.

Referring to FIG. 1C, one embodiment of a stack 120 is illustrated. In the present example, the NIO platform 100 interacts with an operating system (OS) 122 that in turn interacts with a device 124. The interaction may be direct or may be through one or more other layers, such as an interpreter or a virtual machine. The device 124 can be a virtual device or a physical device, and may be standalone or coupled to a network.

Referring to FIG. 1D, another embodiment of a stack 126 is illustrated. In the present example, the NIO platform 100 interacts with a higher layer of software 128a and/or a lower layer of software 128b. In other words, the NIO platform 100 may provide part of the functionality of the stack 126, while the software layers 128a and/or 128b provide other parts of the stack's functionality. Although not shown, it is understood that the OS 122 and device 124 of FIG. 1C may be positioned under the software layer 128b if the software 128b is present or directly under the NIO platform 100 (as in FIG. 1C) if the software layer 128b is not present.

Referring to FIG. 1E, one embodiment of a system 130 is illustrated. The system 130 is one possible example of a portion or all of the device 124 of FIG. 1C. The system 130 may include a controller (e.g., a processor/central processing unit (“CPU”)) 132, a memory unit 134, an input/output (“I/O”) device 136, and a network interface 138. The components 132, 134, 136, and 138 are interconnected by a data transport system (e.g., a bus) 140. A power supply (PS) 142 may provide power to components of the system 130 via a power transport system 144 (shown with data transport system 140, although the power and data transport systems may be separate).

It is understood that the system 130 may be differently configured and that each of the listed components may actually represent several different components. For example, the CPU 132 may actually represent a multi-processor or a distributed processing system; the memory unit 134 may include different levels of cache memory, main memory, hard disks, and remote storage locations; the I/O device 136 may include monitors, keyboards, and the like; and the network interface 138 may include one or more network cards providing one or more wired and/or wireless connections to a network 146. Therefore, a wide range of flexibility is anticipated in the configuration of the system 130, which may range from a single physical platform configured primarily for a single user or autonomous operation to a distributed multi-user platform such as a cloud computing system.

The system 130 may use any operating system (or multiple operating systems), including various versions of operating systems provided by Microsoft (such as WINDOWS), Apple (such as Mac OS X), UNIX, and LINUX, and may include operating systems specifically developed for handheld devices (e.g., iOS, Android, Blackberry, and/or Windows Phone), personal computers, servers, and other computing platforms depending on the use of the system 130. The operating system, as well as other instructions (e.g., for telecommunications and/or other functions provided by the device 124), may be stored in the memory unit 134 and executed by the processor 132. For example, if the system 130 is the device 124, the memory unit 134 may include instructions for providing the NIO platform 100 and for performing some or all of the methods described herein.

The network 146 may be a single network or may represent multiple networks, including networks of different types, whether wireless or wireline. For example, the device 124 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 124 with external devices.

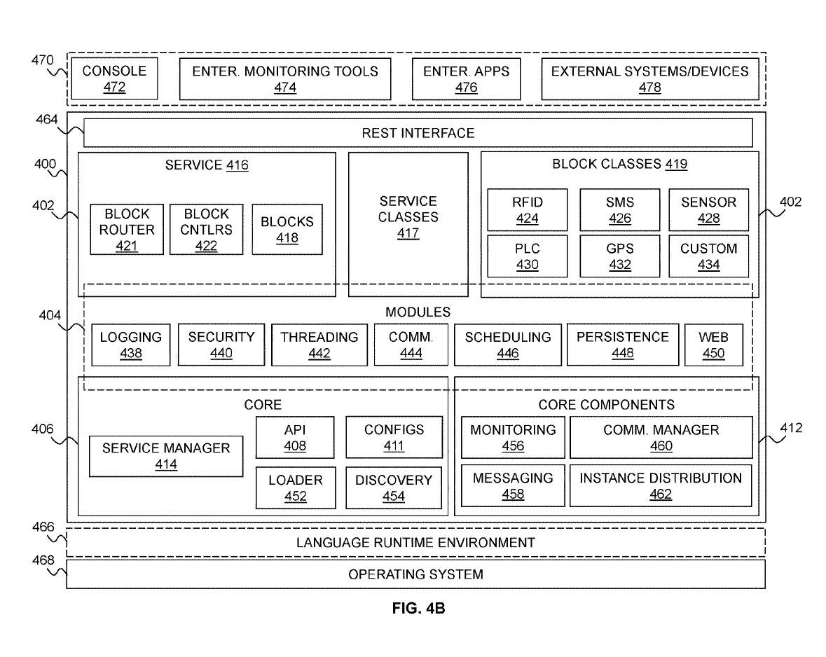

Referring to FIG. 2, a NIO platform 200 illustrates a more detailed embodiment of the NIO platform 100 of FIG. 1A. In the present example, the NIO platform 200 includes two main components: service classes 202 for one or more services that are to provide the configurable processing functionality 106 and core classes 206 for a core that is to provide the support functionality 108 for the services. Each service corresponds to block classes 204 for one or more blocks that contain defined task specific functionality for processing niograms. The core includes a service manager 208 that will manage the services (e.g., starting and stopping a service) and platform configuration information 210 that defines how the NIO platform 200 is to be configured, such as what services are available when the instance is launched.

When the NIO platform 200 is launched, a core and the corresponding services form a single instance of the NIO platform 200. It is understood that multiple concurrent instances of the NIO platform 200 can run on a single device (e.g., the device 124 of FIG. 1C). Each NIO platform instance has its own core and services. The most basic NIO platform instance is a core with no services. The functionality provided by the core would exist, but there would be no services on which the functionality could operate. Because the processing functionality of a NIO platform instance is defined by the executable code present in the blocks and the services are configured as collections of one or more blocks, a single service containing a single block is the minimum configuration required for any processing of a niogram to occur.

It is understood that FIG. 2 illustrates the relationship between the various classes and other components. For example, the block classes are not actually part of the service classes, but the blocks are related to the services. Furthermore, while the service manager is considered to be part of the core for purposes of this example (and so created using the core classes), the core configuration information is not part of the core classes but is used to configure the core and other parts of the NIO platform 200.

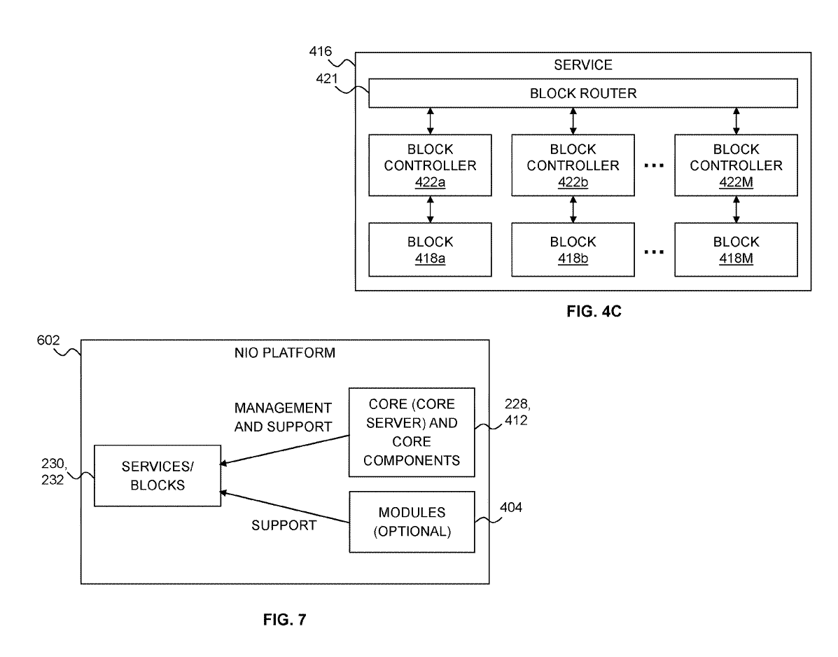

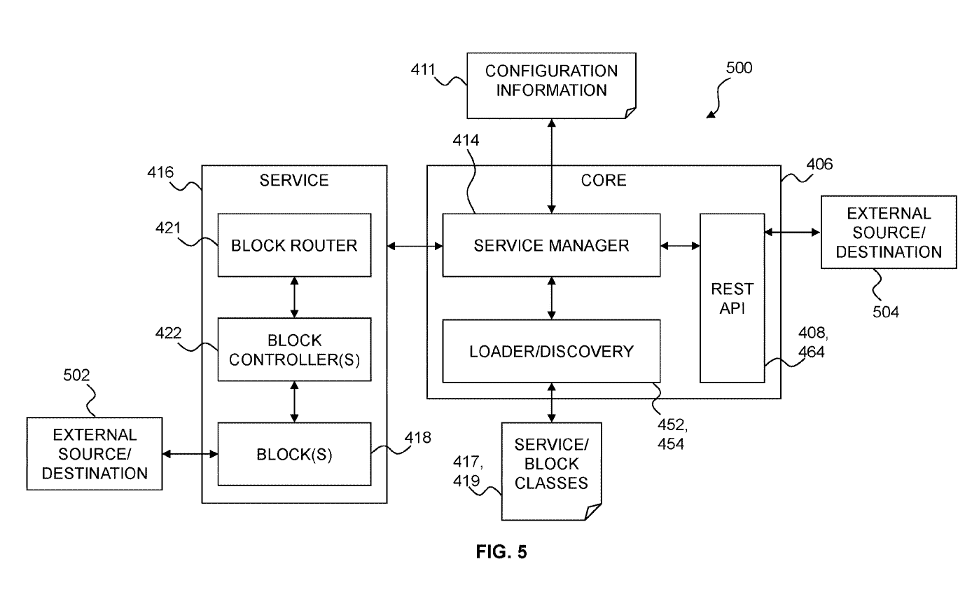

With additional reference to FIGS. 3A and 3B, another embodiment of the NIO platform 200 of FIG. 2 is illustrated as a NIO platform 300 prior to being launched (FIG. 3A) and as a NIO platform instance 302 after being launched (FIG. 3B). FIG. 3A illustrates the NIO platform 300 with core classes 206, service classes 202, block classes 204, and configuration information 210 that are used to create and configure a core 228, services 230a-230N, and blocks 232a-232M of the NIO platform instance 302. It is understood that, although not shown in FIG. 3B, the core classes 206, service classes 202, block classes 204, and configuration information 210 generally continue to exist as part of the NIO platform instance 402.

Referring specifically to FIG. 3B, the NIO platform instance 302 may be viewed as a runtime environment within which the core 228 creates and runs the services 230a, 230b, . . . , and 230N. Each service 230a-230N may have a different number of blocks. For example, service 230a includes blocks 232a, 232b, and 232c. Service 230b includes a single block 232d. Service 230N includes blocks 232e, 232f, . . . , and 232M.

One or more of the services 230a-230N may be stopped or started by the core 228. When stopped, the functionality provided by that service will not be available until the service is started by the core 228. Communication may occur between the core 228 and the services 230a-230N, as well as between the services 230a-230N themselves.

In the present example, the core 228 and each service 230a-230N is a separate process from an operating system/hardware perspective. Accordingly, the NIO platform instance 302 of FIG. 3B would have N+1 processes running, and the operating system may distribute those across multi-core devices as with any other processes. It is understood that the configuration of particular services may depend in part on a design decision that takes into account the number of processes that will be created. For example, it may be desirable from a process standpoint to have numerous but smaller services in some embodiments, while it may be desirable to have fewer but larger services in other embodiments. The configurability of the NIO platform 300 enables such decisions to be implemented relatively easily by modifying the functionality of each service 230a-230N.

In other embodiments, the NIO platform instance 302 may be structured to run the core 228 and/or services 230a-230N as threads rather than processes. For example, the core 228 may be a process and the services 230a-230N may run as threads of the core process.

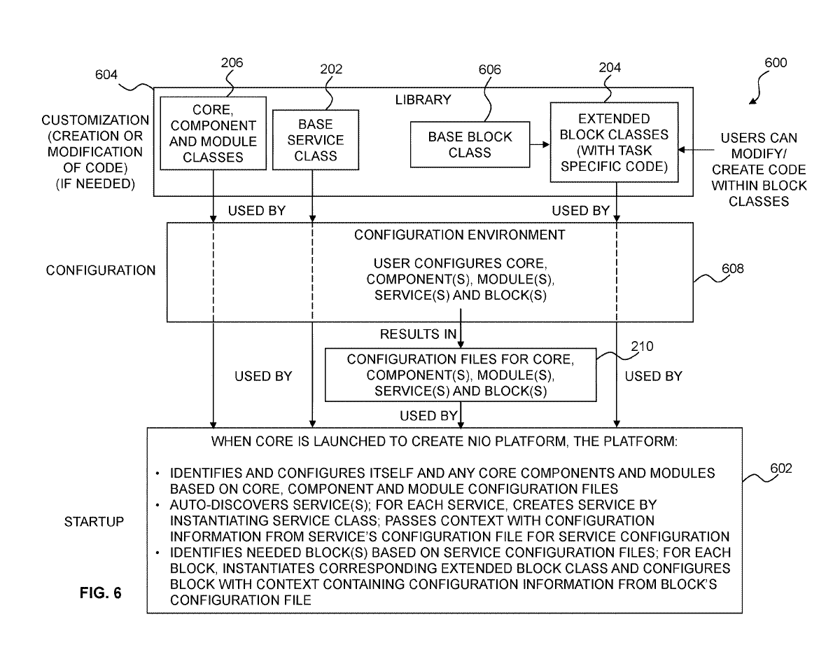

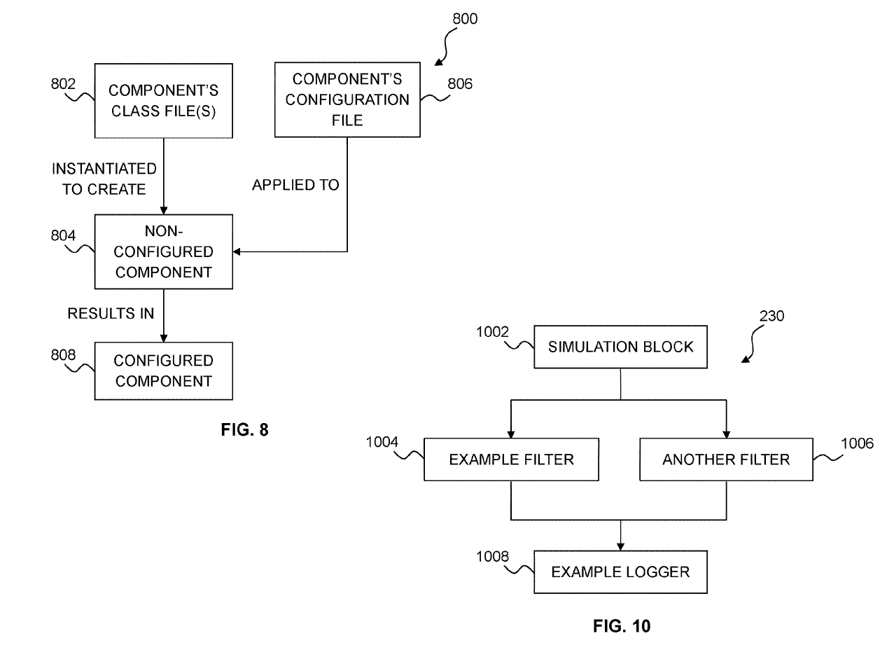

Referring to FIGS. 4A and 4B, a NIO platform 400 illustrates a more detailed embodiment of the NIO platform 100 of FIG. 1A, the NIO platform 200 of FIG. 2, or the NIO platform 300 of FIG. 3A from a platform perspective (FIG. 4A) and a stack perspective (FIG. 4B). For purposes of example, the NIO platform 400 is written in the programming language Python, but it is understood that any suitable programming language can be used, including but not limited to languages such as C++. The NIO platform 400 is built on a core 406. When launched, a core process creates a core server (generally referred to herein as the core), which forms the underlying structure of the NIO platform 400.

Service components 402 include services 416 and blocks 418 from a functional perspective, even though the services 402 and blocks 418 are illustrated separately in the stack of FIG. 4B. As previously described, the service components 402 are responsible for user defined functionality by enabling block and service functionality to be defined and changed. Much of the functionality in a service component 402 can be user specific, which allows for a high level of customization.

In the present example, the service components 402 are provided as service classes 417 that define how services 416 are created and executed. The execution of services 416 includes routing signals, executing commands, and defining class structures. Some or all of the service classes 417 that form a service component 402 can be extended to define new functionality. This provides a large amount of flexibility in a neutral manner, as a user can define whatever functionality is desired through the service components 402 and that functionality will be executed by the NIO platform 400.

Generally, the service components 402 in one platform instance have no dependency or awareness of another platform instance's service components, which allows for each particular platform instance to be configured without having to take into account how the configuration would affect other platform instances. Furthermore, changing functionality in a service component 402 has no effect on the core 406. This ensures that the core 406 does not have to be modified to be compatible with the service components 402.

In the present example, from a functional perspective, the service components 402 include blocks 418, block classes 417, block instances (also referred to simply as “blocks”), block groups, commands, services 416, and niograms.

In the NIO platform 400, blocks classes 419 may include classes for both custom blocks 434 and blocks having predefined functionality such as RFID block(s) 424, short message service (SMS) block(s) 426, sensor block(s) 428, programmable logic controller (PLC) block(s) 430, and global positioning satellite (GPS) block(s) 432. Although not shown, it is understood that many other blocks 418 may be defined for use with systems using Electronic Product Codes (EPCs) (a trademark of EPCglobal Inc. of Lawrenceville, N.J.), Low Level Reader Protocol (LLRP) information, email (e.g., simple mail transfer protocol (SMTP)), hypertext transfer protocol (HTTP) documents, and/or any other protocols.

Block classes 419 are classes that specify the metadata template and computational functionality of block instances. In the present example, blocks 418 are built from block classes 419 that extend a BaseBlock class and can specify custom behavior by overriding any of the following five basic methods provided by the BaseBlock class: BaseBlock.initialize, BaseBlock.configure, BaseBlock.start, BaseBlock.stop, and BaseBlock.processSignals. These methods are used by the service 416 that corresponds to the blocks 418.

The BaseBlock.initialize method is called to instantiate the block 418 using the corresponding block class 419. The BaseBlock.configure method is called to configure the block 418 after initialization using a saved block configuration. The BaseBlock.start method is called to start the block 418 after instantiation and configuration. The BaseBlock.stop method is called to stop the block 418 (e.g., when the containing service 416 has been stopped). The BaseBlock.processSignals contains the main processing functionality provided by the block 418. The BaseBlock.processSignals method processes a (possibly empty) list of incoming signals and notifies the service 416 when done (e.g., via a notifySignals method, which is discussed below).

A block instance is created when a block 418 is instantiated from a block class 419. A block instance may be viewed as the fundamental unit of computation in the NIO platform 400 and may be customized and configured as prescribed by the block class 419 being instantiated. A block instance only exists inside a service 416. Accordingly, when a service 416 is started or stopped, the blocks 418 inside that service 416 are also started or stopped. In the present example of the NIO platform 400, there is no concept of a block 418 running outside a service 416.

Block configurations, which are used to configure blocks 418, can be reused in different services 416 and may be viewed as saved configurations of blocks 418. When the configuration of a block 418 is changed, it will be changed for all blocks 418 in all services 416 that contain it. However, if a service 416 is running, the configuration of the running block instance may only be updated after the service 416 is restarted.

In other embodiments, a block instance may be updated without restarting the service 416. For example, if the block instance is not currently in use by the service 416, the block instance may be stopped, reconfigured with the new block configuration, and restarted. Alternatively, if not in use, the block instance may be destroyed and a new block instance may be instantiated with the new block configuration. In such embodiments, the service 416 may continue running or may be paused, rather than stopped and restarted.

Outside agents (e.g., other services and/or external APIs) may modify the behavior of specific blocks 418 via a command API (discussed below). Within the command API, block instances may be referenced by a service level block alias and/or a block group level. For this reason, globally unique block identifiers are not necessary in the present example, although they may be used in some embodiments.

Block instances can directly receive and send signals without going through the service 416. In this respect, a block 418 can serve as an interface through which signals can enter the NIO platform 400 and be sent from the NIO platform 400.

With additional reference to FIG. 4C, as described previously, services 416 are the main organizational component of the NIO platform's configurable processing functionality. Each service 416 maintains a block router 421, a block controller 422 for each block 418a-418M, its own configuration parameters, a list of block instances for that service, and an associative list of block aliases. In the present embodiment where the service 416 is a process, the service process may handle all communications between the service 416 and the service manager 414. In other embodiments, the block router 421 or another component within the service 416 may handle such communications.

The block controllers 422a-422M serve as intermediaries between the block router 421 and their respective blocks 418a-418M. In performing this intermediary function, the block controllers 422a-422M mimic both the block router 421 and the blocks 418a-418M. For example, the block router 421 may instantiate the block controller 422a, which in turn instantiates the block instance 418a. In other embodiments, the block router 421 may instantiate the block controller 422a and the block instance 418a. After instantiation, the block router 421 communicates with the block controller 422a as though the block controller 422a is the block 418a. Similarly, the block 418a communicates with the block controller 422 as though the block controller 422 is the block router 421. Accordingly, removal of the block controllers 422a-422M would not prevent communications between the block router 421 and the blocks 418a-418M, but would remove the functionality provided by the block controllers 422a-422M from the service 416 unless that functionality was included elsewhere in the service (e.g., in the block router 421 and/or the blocks 418a-418M).

The block controllers 422a-422M may be configured to perform error handling and/or other functions for their respective blocks 418a-418c. Generally, only functions that are likely needed by many or all blocks may be provided by the block controllers 422a-422M. This enables a generic block controller to be used for a block 418 regardless of the functionality of that particular block. Accordingly, each block controller 422a-422M is identical in the present example. In other embodiments, block controllers having different configurations may be used for different blocks based on the need of a particular block and/or other criteria.

The block controllers 422a-422M may be configured to make certain decisions about whether to pass information to the block router 421. For example, when the block 418a throws an error, the error is caught by the block controller 422a. The block controller 422a may then decide how to handle the error, including passing the error up to the block router 421, ignoring the error, and/or taking other action. For example, if the error indicates that the block instance 418a has stopped working, the block controller 422a may proactively notify the block router 421 or may wait to notify the block router 421 until the block router 421 attempts to use the block instance. Removal of the block controller 422a would remove this error handling functionality so that when the block 418a throws the error, the block router 421 would catch it.

The block router 421 handles data flow among the blocks 418a-418M by defining the flow of niograms between blocks 418a-418M within the service 416. More specifically, communication between block instances within the service 416 is managed by the block router 421 via a Blockrouter.notifySignals() method and a processSignals() method. The Blockrouter.notifySignals() call is issued by a block 418 that has output ready. The Blockrouter.notifySignals() method identifies the source block and contains the niogram(s) forming the output. For example, the Blockrouter.notifySignals() may be implemented as Blockrouter.notifySignals(source block identifier, niogram(s)).

In the current embodiment, this call is made whenever a block 418 within the service 416 has output and the block need not be aware of the service at all. In other words, the block 418 receives input, processes, the input, calls Blockrouter.notifySignals(), and is done without even knowing that it is part of a service. In other embodiments, the block 418 may know the service 416 of which it is a part, which enables the block 418 to notify the signal to the particular service 416. Although the output itself is passed as a parameter in the method call in the present embodiment, it is understood that other processes may be used to transfer the output. For example, a pointer to the output may be passed rather than the output itself.

When Blockrouter.notifySignals() is invoked, the block router 421 looks up the source block 418 in the routing table to determine the destination block(s) 418 to which the output should be directed. The block router 421 then calls processSignals() on each of the next blocks in succession. The process Signals() method identifies the destination block and contains the niogram(s) to be processed (e.g., the niograms that were the output of the source block). For example, the processSignals() method may be implemented as processSignals(destination block identifier, niogram(s)). Although the niogram(s) themselves are passed as a parameter in the method call in the present embodiment, it is understood that other processes may be used to transfer the niogram(s). For example, a pointer to the niogram(s) may be passed rather than the niogram(s) themselves. The block router 421 may, with each call for processSignals() launch the called block instance in a new thread of the service process.

In the present example, the blocks 418 operate asynchronously (i.e., each block 418 executes independently of other blocks). When a block 418 publishes a niogram to another block 418, the receiving block executes immediately. This means that there is no buffering of niograms between blocks 418 except as needed (e.g., buffering may occur if a thread pool is used and there is no currently available thread for the receiving block) and data passes through the service 416 as quickly as the blocks 418 can process the data. The processing speed for a given block 418 may depend on the complexity of the block's instructions, as well as on factors outside of a block's control, such as the speed of the device's processor and the amount of processor time allocated to the block's thread.

Services 416 are started and stopped by commands issued through a service API. When a service 416 receives the start command, it “starts” all blocks 418 contained by the service 416. Similarly, when a service 416 receives the stop command, it stops all blocks 418 contained by the service 416. It is noted that the blocks 418 may not actually be “started,” but simply notified that the service 416 encapsulating them has been started. If desired, the blocks 418 can then use the notification hook to execute some functionality (e.g., a block 418 that polls an external API and needs to know when to start polling could use the notification as the polling trigger).

In some embodiments, stopping a service 416 may result in the loss of any information (e.g., the local state) in any corresponding block instances. For example, in the current example that uses Python objects for block instances, block objects can be wiped out by calling the Blockinstance.destroy() method. In other embodiments, it may be desirable to maintain the local state after a service 416 is stopped. For example, instead of wiping out the local state of instantiated blocks when a service 416 is stopped, the service 416 can instead be paused to stop the service's execution temporarily without losing potentially valuable data. This may be accomplished by issuing the stop command to all the blocks 418 in the service 416 without doing the normally associated cleanup (e.g., without calling Blockinstance.destroy() and/or in other ways.

Commands are used to interact with blocks 418 and must be reachable from outside the blocks 418. Accordingly, how a block 418 defines and exposes a command needs to be known. For example, a block 418 may be used to provide SMS functionality. To accomplish this, the block 418 may be configured to expose a command “sendSMS.” For the block 418 to function within the NIO platform 400, the method for actually sending an SMS would be written in the block 418 in executable instructions, and then the method would have to be declared as a command to make it reachable through, for example, a REST API. A command to call the method may be formatted in various ways depending on the particular implementation of the block structure, such as a name (e.g., the block's method name), title (e.g., a descriptive name), and arguments. It is noted that this may be the same command structure used to start/stop services.

As previously described, the niogram is the primary mechanism for intra-service data transmission (e.g., between blocks/block groups). All blocks 418 may accept and emit generic niograms of a base niogram class. The base niogram class generally has no required fields and does not require validation. The base niogram class simply exposes a way to add or remove attributes, and serialize/de-serialize the niogram into different forms (e.g., JavaScript Object Notation (JSON)). In the present example, an instance of the base niogram can add or remove attributes freely.

With continued reference to FIG. 4B, the modules 404 are modules containing predefined code that the NIO platform 400 may use itself and that blocks 418 may also use. The modules 404 may provide functionality defined with respect to each module, such as a logging module 438, a security module 440, a threading module 442, a communication module 444, a scheduler module 446, a persistence module 448, and/or a web server module 450. Some or all of the modules 404 are designed so that they can be exchanged for different implementations of the same functionality without affecting existing blocks or platform functionality. A role of the modules 404 within the NIO platform 400 is to provide swappable functionality for different platform instances without affecting the blocks 418 and the core 406. The modules 404 provide APIs that can be called by blocks 418 and the core 406. The result of the API call is defined by the functionality of the called module 404.

The functionality defined in the modules 404 spans an entire platform instance. Accordingly, when the functionality within a module 404 is changed, the entire platform instance will use the new version of the module. For example, if the logging module 438 is changed to log to a remote database instead of a local file, all logging calls (in the core 406 and in the services 416) will start logging accordingly. However, such changes may require a platform instance restart to take effect.

The modules 404 support the ability of the NIO platform 400 to run within different environments without having to modify the core design of the NIO platform 400. For example, if a particular environment does not support some needed feature, the module 404 responsible for that feature can be reconfigured or replaced with functionality that is supported by the environment. Accordingly, by changing modules 404 as needed, platform instances may be run in varied environments that have different needs.

Depending on the functionality of the particular module 404, a module 404 may need to initialize its functionality based on variable data. For example, the logging module 438 may need a file name where the information is saved, while the communication module 444 may need a list of current publishers in the platform instance. In order to accomplish this, both the core 406 and the services 416 initialize the modules 404 by calling a setup method and passing context information with this data.

For services 416, the module's initialization data may come directly or indirectly as part of the service's initialization data. For example, the data may be provided indirectly by providing the name of the configuration file where the data for the module 404 resides. For the core 406, the data may reside in a system wide configuration file that can be read during start up and then used for initializing the module 404.

The logging module 438 is used to provide logging functionality and, like all of the modules 404, may provide a customized solution or may use an existing solution, such as Python's built-in logging module. The security module 440 enables blocks 418 to interface with internal or external security applications. The threading module 442 provides threading support and may provide one or more threading options. The communication module 444 enables services 416 within a platform to subscribe and publish niograms. The niograms can be transported within the platform instance or between platform instances. The scheduler module 446 facilitates the execution of tasks at scheduled intervals or at a single point in the future. The persistence module 448 enables blocks 418 and core components to “persist” certain information relevant to them that will survive through a platform instance restart.

The web server module 450 enables services 416 and/or blocks 418 to expose a web server for interacting on an isolated port. In addition, the core 406 may use the web server module 450 to expose a web server that hosts the API 408. Services 416, which operate as different processes in the present example, can ease the load on the core process by receiving data directly through their own web server. Without this, blocks/services use commands to receive data through HTTP, but those commands are regulated and passed through the core 406. By using the web server module 450, the blocks 418 can listen directly to a port for incoming HTTP requests and handle the requests accordingly without loading the core process.

In the present example, the core 406 includes an API 408, a service manager 414, and a configuration manager 410. The configuration manager 410 includes configurations 411, a loader 452, and discovery functionality 454, which may be part of the loader 452 in some embodiments. In other embodiments, the configuration manager 410 may not exist as a component, but the loader/discovery functionality and the configurations may continue to exist within the core 406 (e.g., as part of the service manager 414 or elsewhere). The core 406 may also include core components 412 in some embodiments. The core 406 maintains the services 416 provided by the NIO platform 400. The core 406 is not directly exposed to the service components 402 and can use the modules 404.

The API 408 represents multiple APIs, but it is understood that blocks 418 and block groups may be able to receive and/or send information without passing through the API 408 in the core 406. For example, a block may be able to send and receive SMS messages without using the API 408. It is understood that many different APIs and API calls may be defined, and that the examples described below are only for the purpose of illustrating how various components of the NIO platform 400 may be accessed and managed. In the present example, the API 408 includes a block API, a block configuration API, a command API, a mechanism for providing custom APIs, and a service API.

The block API enables a user to alter the state of the blocks 418 loaded in the NIO platform 400. For example, the block API enables a user to add, reload, and/or remove blocks 418 without having to restart the instance in which the blocks 418 are located. For purposes of example, the block API follows the create, read, update, delete (CRUD) model, exposing four methods to interact with blocks 418, as well as an instances endpoint to interact with a block's instances.

A create method adds a new block 418 to an instance and may be accomplished in multiple ways. For example, a file, module, and/or package may be attached for use as the block 418, a file name where the block code is loaded may be referenced, a remotely hosted block may be referenced, and/or a class may be specified and the NIO platform 400 may be configured to locate and retrieve the class's code.

A read method returns a list of blocks 418 and therefore exposes the functionality of the NIO platform 400. In addition to the list of blocks 418, the read method may return other block meta information, such as version, dependencies, and install time.

An update method refreshes a block 418 in the NIO platform 400. This may include reloading the block's code, re-validating, and updating references. The update method may not update the block code for block instances that are currently in running services 416. In such cases, the service 416 may have to be restarted to realize the block code. In other embodiments, a block instance may be updated without having to restart the service 416.

A delete method enables a block 418 to be deleted from the NIO platform 400. Any block instances of the block 418 will also be deleted. Any blocks 418 that are in running services 416 will continue to run, but when the service 416 is restarted, an error will be thrown and the service 416 will not be able to start unless the service 416 is updated to reflect the deletion.

An instances method enables interaction with the instances of a block 418. For example, “instances” may be viewed as a custom endpoint that is essentially an alias for/instances?block=BlockName. The instances method allows a user to modify the block instances associated with a given block 418. This will be discussed in greater detail below with respect to the block instance API.

The block configuration API enables a user to alter the state of the block instances loaded in the NIO platform 400. Because block configurations are configured instances of blocks 418, some API calls can happen through the previously described block API. For purposes of example, the block configuration API follows the CRUD model, but may also define some alternative methods.

A create method adds a new block configuration. To create a block configuration, a relevant block 418 must exist for the configuration. As a result, configuration creation can go through the specified block's API endpoint within the block API. Configuration creation can also go through the NIO platform's block configuration API as long as a valid block 418 is specified.

A read method returns a list of block configurations, although there may be multiple ways to see the block configurations that are configured within the NIO platform 400. For example, by hitting the main block configurations endpoint, all configurations in the NIO platform 400 will be returned. Further refinement can be achieved by specifying a block name as a parameter or issuing the GET to the block configuration's endpoint. The GET calls will return the configuration's name as well as the configuration defined within the block 418.

An update method updates the configuration of a block configuration on the NIO platform 400. Blocks 418 that are part of a currently running service 416 will not have their configuration updates realized until the service 416 is restarted.

A delete method enables a block configuration to be deleted from the NIO platform 400. This removes a block configuration from the NIO platform 400, but not the block 418 itself. If the block 418 is part of a running service 416, the service 416 will continue to run with the original block code. When the service 416 is restarted, an error will be thrown indicating the block 418 cannot be found.

The command API enables a user to interact with previously described command handlers that have been defined to expose commands for blocks 418. Services 416 and blocks 418 can both be commanded. However, in the present embodiment, because blocks 418 do not stand alone but exist within a service 416, the caller must go through the service 416 to command a block 418. Depending on the particular implementation, a command may be called in many different ways, including hypertext transfer protocol (HTTP) methods such as GET and POST. The block 418 being called should define the proper handling for each type of allowed call.

A command method can be used to command a block 418 inside a service 416. For example, the method may be structured as/services/ServiceName/BlockAlias/commandName. The root of this API call is the service 416, since the block 418 inside of that service 416 is what will be commanded. If the specified service 416 does not exist, an error will be thrown. The next component in the method is the BlockAlias. By default, this will be the block configuration name. However, if a service builder wishes to include more than one of the same blocks 418 within a service 416, a block alias can be defined for each configuration of that block 418. The final component is the command name. This command must be a valid command as defined by the block 418 connected to BlockAlias.

The mechanism for defining custom APIs leverages the ability of blocks 418 to define custom command handlers. Because of this, custom APIs can be written as blocks 418 and implemented as block configurations within a service 416. For example, a service builder can drop an API block 418 into any point in a service 416. The API block 418 does not affect the operation of the service 416, but does provide a new API endpoint that can be used to leverage attributes of the service 416 at the point where the block 418 is inserted.

The service API enables a user to alter the state of the services 416 in the NIO platform 400. For purposes of example, the service API follows the CRUD model, as well as a command model that allows a user to start/stop a service 416.

A create method adds a new service 416 to the NIO platform 400. The specification of the service 416 (e.g., blocks and block mappings) may be included in the body of the call. A read method returns a list of services 416 and their configuration. This information may include the blocks 418 within a service 416, the state of the service 416 (e.g., running or stopped), and any other configuration options specified when the service 416 was created. An update method updates a service's configuration. If the service 416 is currently running, the configuration update will be accepted, but the changes will not be realized until the service 416 is restarted. A delete method removes a service 416 from the NIO platform 400. If the service 416 is currently running, this call will return an error. The service 416 should be stopped before being deleted. A command method is used to start or stop a service 416. If a problem exists with the configuration of a service 416 (e.g., there are non-existent blocks 418, block instances with an invalid block 418, and/or other validation issues), the call will return an error.

In the present embodiment, the configuration manager 410 manages configurations 411 for the current instance of the NIO platform 400, loads services 416 and blocks 418 for inspection if needed, and performs auto-discovery. Ideally, the core 402 has no dependency on its functionality (e.g., the blocks 418) or its configuration (e.g., the block instances and services 416). This lack of dependency enables the use of relocatable instance configurations, such as one or more directories specified by a user. Then, when an instance of the NIO platform 400 is launched, the location of the instance configuration will be identified and the NIO platform 400 will load the instance's blocks 418, services 416, and other needed components from that location. This enables a user to version control their configurations, create multiple configurations on the same machine, and easily share and inspect their configurations.

Configurations may be represented within the NIO platform 400 in many different ways. For example, block instances and services 416 may use JSON flat files, SQLite databases, and/or zip files, while blocks 418 may use python files or python module directories. It is understood that these are merely examples and that many different formats may be used to represent configuration information.

The NIO platform 400 may include different types of configurations depending on what part of the NIO platform 400 is being described. Examples include a core configuration, a platform configuration, a core components configuration, a service configuration, and a block configuration. It is understood that these configurations may be stored as separate files or may be combined. Furthermore, any of these configurations may be divided into multiple configurations or combined in many different ways.

The core configuration is directed to settings related to the core 406. These values may be private to the core 406 and visible to the services 402. The platform configuration is directed to settings for the entire NIO platform 400. These include all settings that are visible to the core 406 and to the services 402. The core components configuration is directed to settings related to a specific core component. The service configuration is directed to settings related to a specific service 416. The block configuration is directed to settings related to a specific block 418.

The NIO platform 400 may use a configuration data file that details what is included in the NIO platform 400. This data file may be different from what is actually inside the configuration directory. For example, if a user copies a block file into a block directory, the block file may not be picked up by an instance until the block file is loaded via the block API. At this point, the instance may load that block 418 into the configuration data file. Similarly, block instance configurations may be copied to the directory, but may not be recognized until the instance is restarted. In other embodiments, an instance restart may not be needed in order for the block instance configurations to be recognized.

In some embodiments, the data may reside at a remote location (e.g., in a remote database or a data structure server), which allows definitions to be shared among different platform instances. In such embodiments, the handler to use in loading a particular configuration may be specified through a platform setting. The NIO platform 400 would then instantiate the specified handler and use it to fetch the instance configuration. One example of an instance configuration directory for the NIO platform 400 is illustrated below, with comments in parentheses.

```
/ (The root of the configuration, which can be any directory on a device.)
  /blocks/ (A directory containing the blocks in the instance.)
      /blocks/”specific block name”/ (An example of a directory block.)
      /blocks/blockGroup.py
      /instances/ (A directory containing the block instances in the instance.)
        /instances/”specific block name”.db (An example where the
        blocks are a database.)
        /instances/blockGroup/ (An example where the blocks are
      grouped into a folder.)
          /instances/blockGroup/BigBlockGroup.json
          /instances/blockGroup/LittleBlockGroup.json
      /services/ (A directory containing the services in the instance.)
        /services/EmailNotificationService.json
        /services/WeatherSMSService.db
      config.db (A set of data representing what is configured in the
    instance.)
```

The core components 412 are modules containing predefined code that the NIO platform 400 may use. The core components 412 provide functionality to the NIO platform 400 and may include modules such as a monitoring module 456, a messaging module 458, a communication manager module 460, and/or an instance distribution module 462.

The core components 412 are somewhat different from core functionality provided by the configuration manager 410 and service manager 414. While core functionality is generally hidden from block writers and required for operation of the NIO platform 400, core components 412 are swappable components (similar to the modules 404l) that are positioned within the core 406 and provide functions usable by the core 406. Like the core functionality, the core components 412 are hidden from block writers (unlike the modules 404). Unlike the core functionality, the core components 412 are not required for the NIO platform 400 to run. However, it is understood that certain implementations of the NIO platform 400 may rely on the core components 412 due to the platform's configuration, in which case the functionality of one or more of the core components 412 would be needed to provide the desired functionality. In other words, the NIO platform 400 might run without the needed core components 412, but would be unable to accomplish certain tasks. In other embodiments, the NIO platform 400 may not start without the needed core components 412.

The instance distribution module 462 may be used when more than one platform instance is sharing the services 416. The messaging module 458 provides a way for external systems to send and receive information from the NIO platform 400.

The service manager 414 handles the interaction of the core 406 with the services 416 running in a platform instance. The service manager 414 handles starting and stopping services 416, and may also manage a service's incoming commands (e.g., commands received via the REST interface 464/API 408). The service manager 414 may use functionality provided by the modules 404 and core components 412. The service manager 414 may be accessed from outside the NIO platform 400 via the API 408.

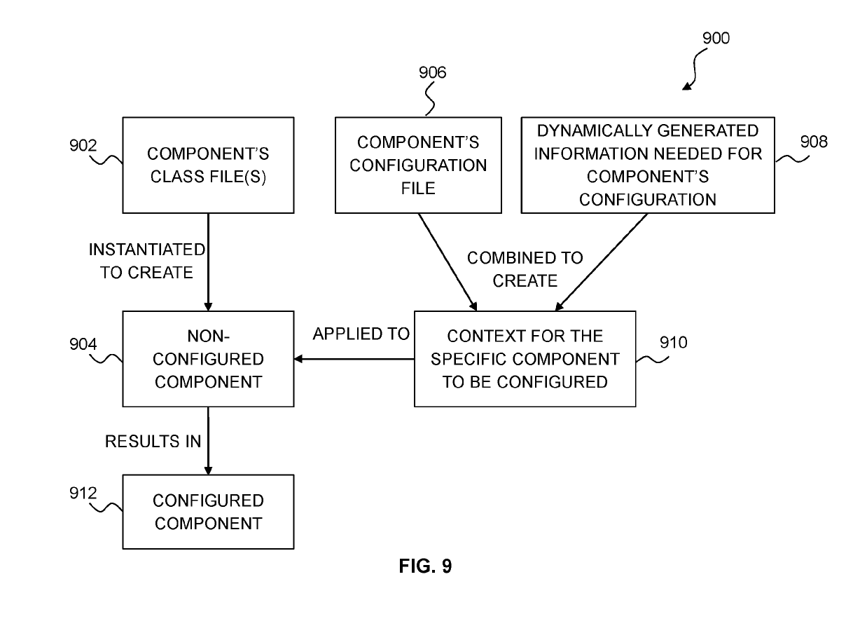

Referring to FIG. 5, one embodiment of an environment 500 that is internal to the NIO platform 400 illustrates a service 416 and the core 406. As previously described, the service process handles communications with the service manager 414, such as commands received through the REST API 408. The block router 421 handles intra-service communications between the blocks 418 via the corresponding block controllers 422 (in embodiments where the block controllers 422 are present). The loader 452 and discovery functionality 454 may be used by the service manager 414 to load service and/or block classes 417, 419 for discovery purposes. External sources/destinations 502 and 504 can communicate via blocks 418 and/or via the REST API 408.

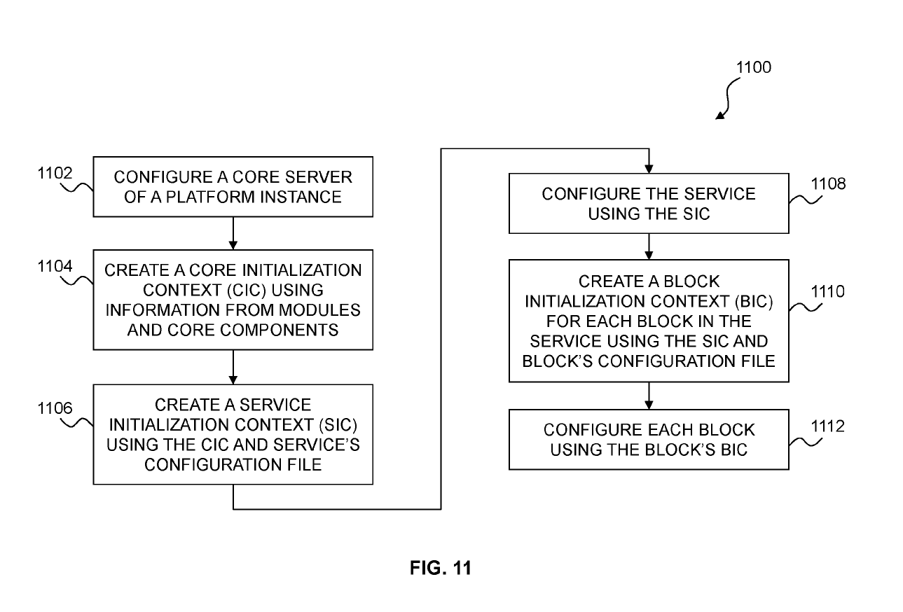

Referring to FIG. 6, a diagram 600 illustrates one embodiment of a workflow that runs from creation to launch of a NIO platform 602 (which may be similar or identical to the NIO platform 100 of FIG. 1A, 200 of FIG. 2, 300 of FIG. 3A, and/or 400 of FIGS. 4A and 4B). The workflow begins with a library 604. The library 604 includes core classes 206 (that include the classes for any core components and modules in the present example), a base service class 202, a base block class 606, and block classes 204 that are extended from the base block class 606. Each extended block class 204 includes task specific code. A user can modify and/or create code for existing blocks classes 204 in the library 604 and/or create new block classes 204 with desired task specific functionality. Although not shown, the base service class 202 can also be customized and various extended service classes may exist in the library 604.

The configuration environment 608 enables a user to define configurations for the core classes 206, the service class 202, and the block classes 204 that have been selected from the library 604 in order to define the platform specific behavior of the objects that will be instantiated from the classes within the NIO platform 602. The NIO platform 602 will run the objects as defined by the architecture of the platform itself, but the configuration process enables the user to define various task specific operational aspects of the NIO platform 602. The operational aspects include which core components, modules, services and blocks will be run, what properties the core components, modules, services and blocks will have (as permitted by the architecture), and when the services will be run. This configuration process results in configuration files 210 that are used to configure the objects that will be instantiated from the core classes 206, the service class 202, and the block classes 204 by the NIO platform 602.

In some embodiments, the configuration environment 608 may be a graphical user interface environment that produces configuration files that are loaded into the NIO platform 602. In other embodiments, the configuration environment 608 may use the REST interface 408, 464 (FIGS. 4A and 4B) of the NIO platform 602 to issue configuration commands to the NIO platform 602. Accordingly, it is understood that there are various ways in which configuration information may be created and produced for use by the NIO platform 602.

When the NIO platform 602 is launched, each of the core classes 206 are identified and corresponding objects are instantiated and configured using the appropriate configuration files 210 for the core, core components, and modules. For each service that is to be run when the NIO platform 602 is started, the service class 202 and corresponding block classes 204 are identified and the services and blocks are instantiated and configured using the appropriate configuration files 210. The NIO platform 602 is then configured and begins running to perform the task specific functions provided by the services.

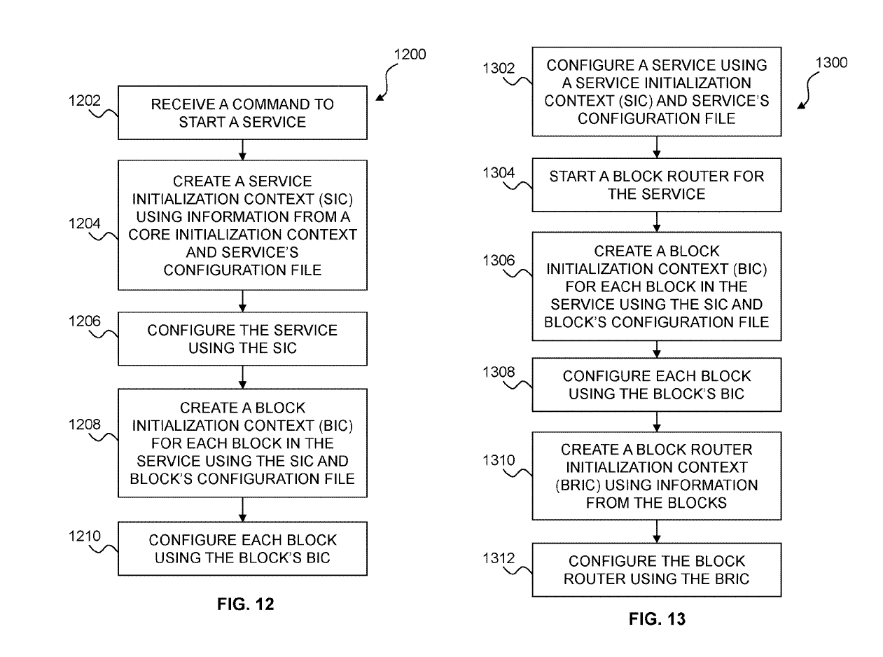

Referring to FIG. 7, one embodiment of the NIO platform 602 is illustrated and described with respect to a startup process. The NIO platform's structure is extremely flexible and can be configured to perform many different tasks in many different environments. Therefore, the startup process that is used when a NIO platform is launched should be robust and able to properly configure any NIO platform regardless of the platform's particular configuration. Configuration variations can include different services 230 and service configurations, different blocks 232 and block configurations, the presence/absence of optional core components 412 and their configurations, different implementations and configurations of modules 404, and different locations for resources.

Furthermore, some configuration information is not available until the startup process is underway. This means that the startup process should accommodate not only predefined configuration information, but also information that is unknown until various points in the startup process are reached.

Accordingly, the startup process in the present example uses both predefined configuration files and dynamically generated objects called contexts that incorporate information not known before startup. This allows configuration information 210 (FIG. 2A) to make its way from a file on disk, through the core 228, and ultimately to the blocks 232 in a new process, while also incorporating dynamically generated information. When finished, the startup process will have properly initialized the NIO platform's components and created a running NIO platform 602 that can perform the tasks it is configured to perform.

As illustrated in FIG. 7, the architecture of the NIO platform 602 can be divided into two main parts: (1) the management and support functionality provided by a core server 228 that forms the base of the NIO platform 602, the core components 412, and optional modules 404, and (2) the task specific functionality provided by the service components (services 230 and blocks 232). The core server 228, core components 412, modules 404, services 230, and blocks 232 are generally all initialized when the NIO platform 602 is launched, although some components (e.g., services 230 and blocks 232) may not be initialized until needed. For convenience, the core server 228, core components 412, modules 404, services 230, and blocks 232 are all generally referred to as “components” in the present embodiment and in some later embodiments. When a particular component is being described, its name will be used (i.e., core server 228, core component 412, module 404, service 230, or block 232).

Each component is initialized by instantiating the component using one or more class files and then configuring the instantiated component. There are two different ways that configuration can occur within the NIO platform 602: (1) using only a configuration file or (2) using a context. The configuration type (i.e., configuration file or context) used with each component is illustrated below in Table 1 along with the part of the NIO platform 602 that is responsible for providing the configuration to the component.

TABLE 1

| | | Configuration |
|---|---|---|
| | Configuration type | information |
| Component | (i.e., configuration file or context) | provided by |
| Core 228 | Core's configuration file | N/A (predefined) |
| (core server) | | |
| Modules 404 | Configuration file | N/A (predefined) |
| | (unique for each module) | |
| Core | Core Initialization Context (CIC) | Core Server |
| components | | (CIC is modifiable |
| 412 | | by Core |
| | | components) |
| Services 230 | Service Initialization Context (SIC) | Service Manager |
| | (unique for each service) | |
| Block routers | Block Router Initialization Context | Service process |
| 421 | (BRIC) (unique for each block | |
| | router) | |
| Blocks 232 | Block Initialization Context (BIC) | Service process |
| | (unique for each block) | |

In Table 1, it is noted that the core server 228 and block routers 421 may not technically be considered components. The core server 228 is the foundation of the entire NIO platform 602 and a block router 421 is considered to be part of the corresponding service 230 rather than a standalone component. However, the core server 228 and block routers 421 are described as components for purposes of this example because they are both instantiated from their own class files and configured using a configuration file (for the core server 228) or a context (for the block router 421) in the same manner as other components.

Although each SIC, BRIC, and BIC are described as being unique to their respective service 230, block router 421, and block 232, it is understood that they may be combined in other embodiments. For example, a single SIC may be used for all services 230, with each service 230 extracting the needed configuration information corresponding to itself from the SIC. Similarly, a single BIC may be used for all blocks 232 in a service 230 or all blocks 232 in the NIO platform 602, with each block 232 extracting the needed configuration information corresponding to itself from the BIC. Accordingly, while individual SICs, BRICs, and BICs are used in the present embodiment, other implementations may be used.

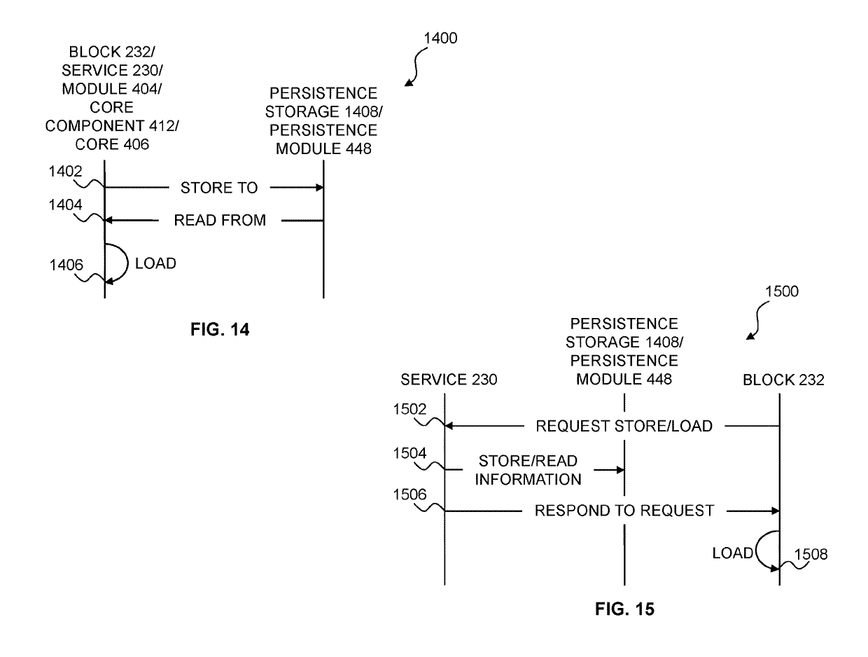

Referring to FIG. 8, one embodiment of a configuration environment 800 within which the core server 228 and modules 404 are configured using only predefined configuration information is illustrated. When the core server 228 and modules 404 are initialized, the component's class file(s) 802 are instantiated to create a non-configured object 804. Configuration information from the component's configuration file 806 is then applied to the non-configured component to form a configured component 808. The configuration information is unique to the component being configured.

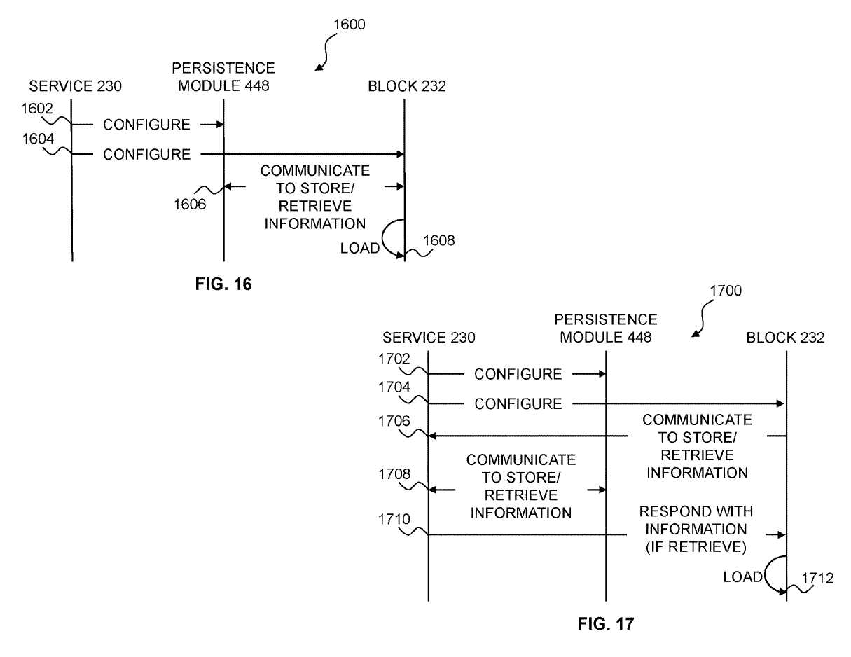

Referring to FIG. 9, one embodiment of a configuration environment 900 within which the core components 412, services 230, block routers 421, and blocks 232 are configured using a context is illustrated. When the core components 412, services 230, block routers 421, and blocks 232 are initialized, the component's class file(s) 902 are instantiated to create a non-configured object 904. Configuration information from the component's configuration file 906 is then combined with dynamically generated configuration information 908 to create a context 910 for the specific component being configured. Accordingly, the context is built from two types of information: (1) the configuration file 906 that contains predefined information for that component known before startup, and (2) the dynamically generated information 908 that is known only after startup. The context 910 then applied to the non-configured component 904 to form a configured component 912.

Referring again to FIG. 7, in the present embodiment of the startup process for the NIO platform 602, the context needed for the core components 412, services 230, block routers 421, and blocks 232 must be built before those components can be started. Therefore, the NIO platform 602 follows a particular order of operations during startup. This order of operations prioritizes the startup order of the core server 228, modules 404, core components 412, services 230, block routers 421, and blocks 232 so that components that contribute information to the contexts used by other components are started first.

The startup process of the NIO platform 602 can be separated between the two parts of the NIO platform illustrated in FIG. 7, with the management and support components being started before the service components. The basic order of startup steps for one embodiment of the NIO platform 602 is shown below in Table 2.

TABLE 2

| | | | Component(s) |
|---|---|---|---|
| Startup | Component | Component(s) involved | involved in |
| step | being started | in initialization | configuration |
| 1 | Core (core | Self (core server process) | Self |
| | server) 228 | | |
| 2 | Modules 404 | Core server | Self |
| 3 | Core | Core server | Self |
| | components 412 | | |
| 4 | Services 230 | Service Manager, | Self |
| | | Block Manager | |
| 5 | Block router 421 | Service process | Self |
| | | corresponding to | |
| | | block router | |
| 6 | Blocks 232 | Service process | Self |
| | | corresponding to block | |

In the present embodiment, it is understood that steps 4-6 of Table 2 occur on a per service basis. For example, step 6 may be executed to initialize the block router 421 for a service #1 at the same time that step 5 is being repeatedly executed to initialize the blocks 232 for a service #2 and step 4 is being executed to initialize the base service process 230 for a service #3. Furthermore, while Table 2 shows that the block router 421 is started before the blocks 232, the block router 421 is created before the blocks 232 are initialized, but is not configured until after the blocks 232 are initialized.

The initialization processes for the core server 228, core components 412, and modules 404 are interleaved. The core process controls the timing. This is illustrated below in outline form:
1. Core process launched
2. Core configuration information parsed
3. Environment settings and variables created
4. Core server created
5. Core server run
   a. Core server configured
      i. Modules discovered
      ii. Modules initialized
      iii. Component manager created
      iv. Core components discovered
         1. Each core component initialized and saved in component manager
      v. CIC created—contains references to components and modules
      vi. CIC passed to each module
      vii. Component manager configured with CIC
         1. Each core component configured with CIC
   b. Core server started
      i. Component manager started
         1. Each core component started

In the present embodiment, the service manager 414 (which is a required core component 412) is responsible for starting any services 230 that can be auto-started. This happens in the start method for the service manager 414, so starting services 230 occurs at 5(b)(i)(1), and starting blocks 232 also occurs at that point because the blocks 232 are considered to be part of their respective service 230 from a startup perspective. The following examples describing the initialization of the core server 228, core components 412, and modules 404 should be read in conjunction with the interleaving illustrated in the outline.

When the core process is launched to start the core server 228, the core process accesses a core configuration file to determine the core server's configuration. An example of a core configuration file is shown below:

[DEFAULT]
[provider]
conf: etc
type: nio.configuration.providers.file.FileConfigurationProvider
[modules]
# location of the module configuration files
conf: etc/modules
load: logging, persistence, scheduler, security, threading, web, communication
[service]
# location of overall service configuration
conf: etc/service.cfg
block_router:
nio.common.block.router.thread_pool_executor.ThreadedPoolExecutorRouter
[environment]
# location of custom extensions (blocks, services, etc)
blocks.path: blocks
[ipc]
request_time_to_live: 5.0
[server]
# settings for the web server that will host the core REST API
host: [[NIOHOST]]
port: [[NIOPORT]]

Based on the core configuration file, the core process is able to load needed components and identify the location of needed resources. Once the core server 228 is started and configured, the core 228 creates a Core Initialization Context (CIC).

The CIC may include information on core components 412, configuration information for modules 404, and a shutdown method that can be called to safely shut down the NIO platform 602. The CIC's information on core components 412 may include a list of core components installed in the node (i.e., the REST API 408/464, service manager 414, component manager (which may be considered to be part of the core server 228, rather than a standalone component), a block manager, the configuration manager 410, and any other components, such as components for messaging 458 and monitoring 456. The configuration information for modules 404 may include a configuration dictionary for each module, specified by a file such as a .cfg file.

The core server 228 registers all of the modules 404 in the CIC, and then passes the CIC to the component manager. The component manager passes the CIC to each core component 412 and allows the core components 412 to read from and alter the CIC so that later components (e.g., services 230 and blocks 232) can access the core components 412 if needed.

The core server 228 starts the modules 404. For each module 404, the core server 228 initializes the module 404 and the module 404 configures itself (if needed) using its own configuration file. The core server 228 registers each module 404 and module specific information in the CIC so that other components will have the information needed to use the modules 404.

After the modules 404 are started and registered in the CIC, the core server 228 starts the component manager. The component manager detects and loads each core component 412, and also passes the CIC to each core component 412. The core components 412 can add their own information to the CIC for use by other components.

Services 230 are started on a per service basis. Each service configuration file has an “auto-start” field. If the field is set to “true,” the core server 228 will automatically start the service 230 during the NIO platform's startup process. If the field is set to “false,” the core server 228 will only start the service 230 after receiving a “start” command instructing it to start the service 230. The same startup process is used regardless of when a service 230 is started.

Services 230 can also be stopped on a per service basis. After being stopped, a service 230 must be restarted to be used. In the present embodiment, the restart process is the same as the original startup process for a service 230. Because the same process is used any time a service 230 is started, all of the contexts for a particular service 230 will be created each time the service 230 is started. This means that previously created contexts are not reused when a service 230 is restarted. In other embodiments, portions or all of the previously used contexts may be reused.

The service manager 414 of the core server 228 uses the CIC to determine which services 230 and modules 404 are loaded into the NIO platform 602 and is responsible for launching the service processes. The service manager 414 creates a Service Initialization Context (SIC) for a service 230 immediately before that service 230 is launched. The SIC is created from the service's unique configuration file and other information that is dynamically generated during startup.

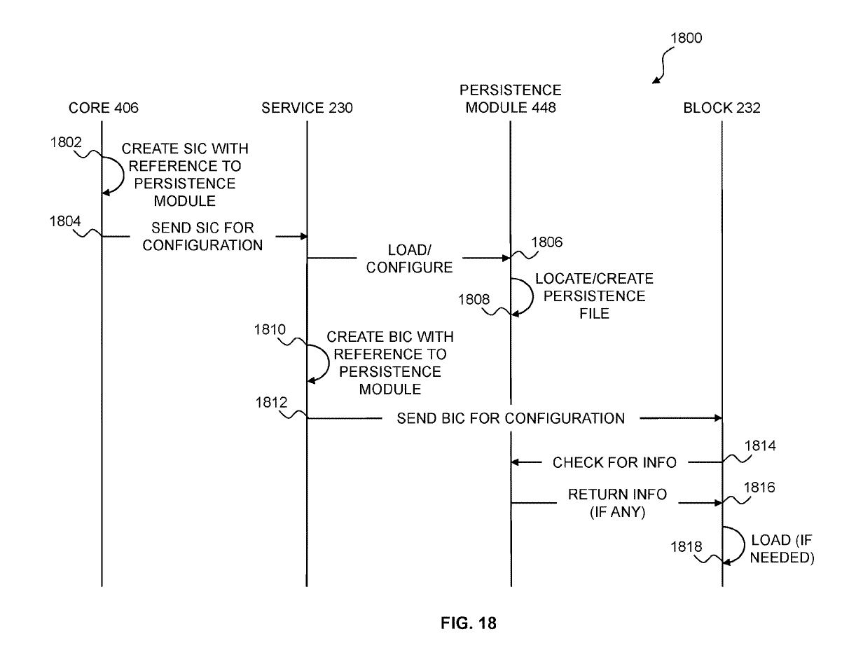

With additional reference to FIG. 10, one embodiment of a service 230 called “MyService” is illustrated. The service 230 has a block configuration with a block 1002 named “SimulationBlock,” a block 1004 named “ExampleFilter,” a block 1006 named “AnotherFilter,” and a block 1008 named “ExampleLogger.” The block 1002 feeds into the two blocks 1004 and 1006, which in turn both feed into the block 1008. An example of a configuration file for the service “MyService” is shown below:

```
{
  ″auto start″: false,
  ″execution″: [
    {
      ″name″: ″SimulationBlock″,
      ″receivers″: [
        ″ExampleFilter″,
        ″AnotherFilter″
      ]
    },
    {
      ″name″: ″ExampleFilter″,
      ″receivers″: [
        ″ExampleLogger″
      ]
    },
    {
      ″name″: ″ExampleLogger″,
          ″receivers″: [ ]
    },
    {
      ″name″: ″AnotherFilter″,
      ″receivers″: [
        ″ExampleLogger″
      ]
    }
  ],
  ″log_level″: ″ERROR″,
  ″mappings″: [ ],
  ″block_router″:
  ″name″: ″MyService″,
  ″status″: ″stopped″,
  ″type″: ″Service″
}
```

The configuration file identifies which blocks 232 are to receive a block's output, which block router 421 is to be used by the service 230 (e.g., the default block router in this case), the name of the service 230, and the status of the service 230.

In the present example, the SIC is the only object sent to the new service process when it is spawned and so needs to contain all the information that the service 230 needs to know from the core server 228. The SIC may include information on a service type, service properties, a service pipe, a core pipe, blocks, module configuration, modules, root, block component data, block specific component data, and service component data. The service type information refers to the base class of the service 230 to be created (e.g., service.base). The service properties information refers to properties with which to configure the service 230. The service pipe information refers to an IPC pipe used to listen to data from the core server 228. The core pipe information refers to an IPC pipe used to send data to the core server 228. The blocks information refers to a list of objects containing block classes and block properties for the service 230.

The module configuration information refers to service specific module configuration information. The modules information refers to a list of modules to initialize, which is needed when the service process is a separate process from the core process and so will have its own module instances. The root information refers to the string path of the root project environment. The block component data information refers to data that the core components 412 can pass to all blocks 232. The block specific component data information refers to data that the core components 412 can pass to specific blocks 232. The service component data information refers to data that the core components 412 can pass to services 230.

It is understood that not every service 230 may need every module 404. For example, a service 230 that only simulates and logs data (e.g., the service 230 of FIG. 10) will likely have no need for the communication module 444. Accordingly, in some embodiments, the core 228 is able to detect this dependency and can withhold the communication module 444 from the list of modules 404 passed to the service 230 in the SIC.

However, if a management core component is installed, it may listen to management signals and attempt to publish them along a channel. Since the service 230 is in its own process, this listener would also exist in the service process so it would require communication to be configured in that process. Therefore, the management core component can amend the modules list in the SIC to include the communication module 444, regardless of whether or not the blocks 232 in the service 230 need the communication module 444.

Block initialization relies on a Block Initialization Context (BIC) created by the service process corresponding to the block 232 being initialized. One BIC is created for each block 232 in the service 230 and is passed to the respective block 232 after the service 230 is configured. The purpose of the BIC is to let the block 232 know pertinent information. The BIC is created from the block's unique configuration file and other information that is dynamically generated during startup. An example of a configuration file for the block “SimulationBlock” of FIG. 10 is shown below:

```
{
  ″attributes″: [
    {
      ″name″: ″″,
      ″value″: {
        ″end″: −1,
        ″start″: 0,
        ″step″: 1
      }
    }
  ],
  ″interval″: {
    ″days″: 0,
    ″microseconds″: 0,
    ″seconds″: 1
  },
  ″log_level″: ″ERROR″,
  ″name″: ″SimulationBlock″,
  ″signal_count″: 1,
  ″signal_type″: ″nio.common.signal.base.Signal″,
  ″type″: ″Simulator″
}
```

The BIC may include information on a block router, block properties, component data, hooks, a service name, a command URL, and a management signal handler. The block router information refers to an instance of the block router 421 that the service 230 will use. The block properties information refers to a dictionary of configured properties for the given block 230. The component data information refers to any data that the core components 412 wish to pass to the block 232. The hooks information refers to system-wide hooks that are available for the block 232 to subscribe to. The service name information refers to the name of the service 230 (e.g., MyService) containing the block 232. The command URL information refers to an accessible URL for the block 232 that enables the block 232 to let external sources know where the block 232 is located. The management signal handler information refers to a method that can be used by the block 232 to notify management signals.

In the present example, neither the block's configuration file nor the BIC has any information about the other blocks 232 in the service 230. Instead, the SIC (via the service configuration file) contains the list of which blocks 232 send output to which other blocks 232.

When the block class gets configured, it takes the block properties that were passed and cross references its class metadata properties. It then sets the properties so that instances of the block 232 can use the properties with which it was configured.

In addition to the general initialization process, a block 232 can be made to perform actions based on start/stop/configure events by overriding methods that are hooked to these events. For example, a user can make a block 232 perform an action when the block 232 is configured by creating an “on configure” method in the block 232. There are some limitations on actions performed during a specific event.

On creation, a block 232 can be instructed to initialize any variables. This can be used to set the variables to a default value.

On configure, the block 232 can be instructed to prepare for handling signals. After a block 232 is configured, it should be assumed that the block 232 can process signals from another block 232. This means that a block 232 that is to log signals to a database should create its database connection in the configure call. No blocks 232 should notify signals or do anything that will cause notification of signals in the configure method.

On start, the block 232 can be instructed to perform any actions that could result in notifying signals. For a simulator, this means starting the simulator job that will notify signals here. A block 232 should not send/notify any signals until it is started. Note that no block 232 will be started until all blocks 232 are configured. This is important because once a block 232 is started, it should be assumed that the block 232 will notify signals and a block 232 must be configured to handle signals.

The initialization processes for the block router 421 and blocks 232 are interleaved. The block router 421 is instantiated before the blocks 232 are initialized, but is not configured until after the blocks 232 are initialized. This is because the blocks 232 need to know information about the block router 421 when the blocks 232 are initialized, and the block router initialization relies on a Block Router Initialization Context (BRIC) that is created by the service process for the main service 230 using information from the blocks 232.

Accordingly, after all of the blocks 232 for the service 230 have been created and configured with their respective BICs, the BRIC is created and the instances of those blocks 232 are passed to it. The BRIC gets passed to the block router 421 of the service 230 so that the block router 421 knows how to route signals between the blocks 232. Without receiving this information from the service 230, the block router 421 will not know where to pass signals when a particular block 232 in the service 230 notifies the service that it has output.

Information contained within the BRIC includes execution and blocks. The execution information refers to a list of block execution routings (e.g., similar to what is in the service's .cfg file). The blocks information refers to a dictionary mapping of block names to instances of blocks.

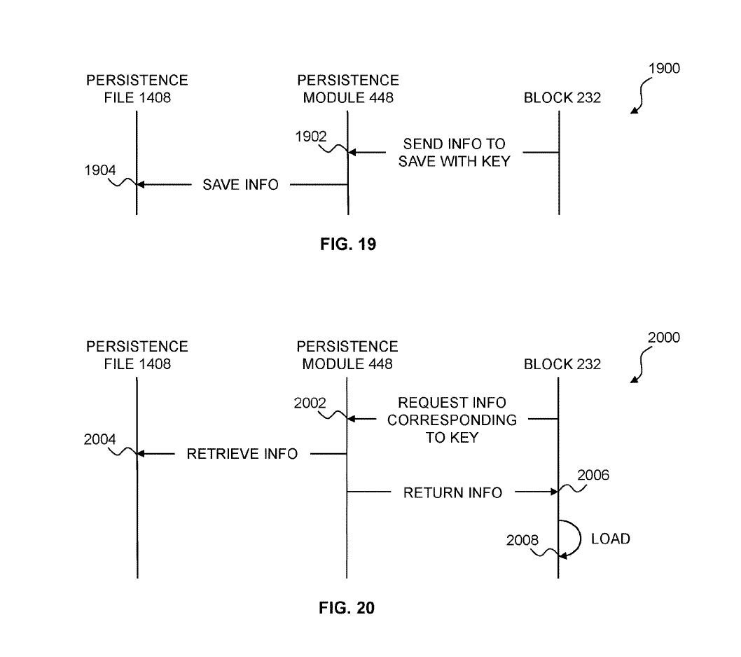

Referring to FIG. 11, a method 1100 illustrates one embodiment of a process that may be executed by the NIO platform of FIG. 7 to create and configure various components during startup. In step 1102, a core server 228 of the NIO platform 602 is configured. In step 1104, a CIC is created using information from modules 404 and core components 412. In step 1106, an SIC is created for a service 230 using information from the CIC and the service's configuration information. In step 1108, the service 230 is configured using the SIC. In step 1110, a BIC is created for each block 232 in the service 230 using the SIC and the block's configuration information. In step 1112, each block 232 is configured using its respective BIC.

Referring to FIG. 12, a method 1200 illustrates one embodiment of a process that may be executed by the NIO platform of FIG. 7 to create and configure various components. In step 1202, a core server 228 of the NIO platform 602 receives a command to start a service 230. In step 1204, an SIC is created for the service 230 using information from a CIC and the service's configuration information. In step 1206, the service 230 is configured using the SIC. In step 1208, a BIC is created for each block 232 in the service 230 using the SIC and the block's configuration information. In step 1210, each block 232 is configured using its respective BIC.

Referring to FIG. 13, a method 1300 illustrates one embodiment of a process that may be executed by the NIO platform of FIG. 7 to create and configure various components. In step 1302, a service 230 is configured using an SIC and the service's configuration information. In step 1304, a block router 421 is started for the service 230. In step 1306, a BIC is created for each block 232 in the service 230 using the SIC and the block's configuration information. In step 1308, each block 232 is configured using its respective BIC. In step 1310, a BRIC is created using information from the blocks 232. In step 1312, the block router 421 is configured using the BRIC.

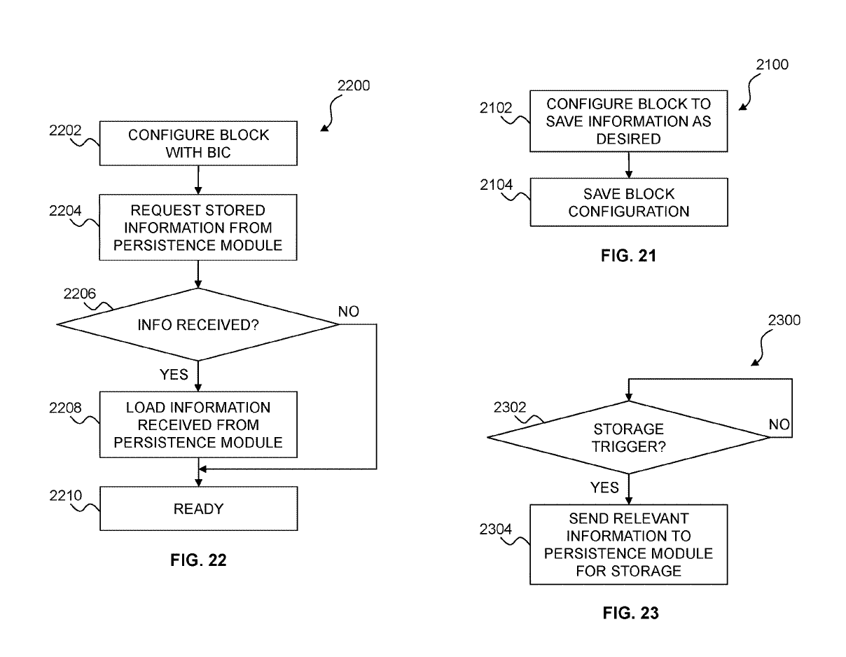

Referring to FIG. 14, a sequence diagram 1400 illustrates one embodiment of a process that may be used to provide information persistence within a NIO platform (e.g., the NIO platform 602 of FIG. 6). As previously described, the NIO platform 602 generally does not store state information or data that is being processed unless instructed to do so. However, for certain applications for which the NIO platform 602 may be used, it can be desirable to save information that can be loaded at a later time. The saving and loading of persistence information enables, for example, a service 230 to be restarted and resume running with blocks 232 that use previously saved states, rather than starting each block with a default state.

Accordingly, in step 1402, persistence information is saved by the core 406 (FIGS. 4A and 4B), a core component 412, a module 404, a service 230, and/or a block 232. For purposes of clarity, only the block 232 will be discussed hereafter, but it is understood that the other components of the NIO platform 602 may also save persistence information. The act of saving the persistence information can be triggered in various ways, such as by the receipt of a save command, the receipt of a stop command (e.g., save a block state when a service and its blocks are stopped), the expiration of a timer (e.g., save every thirty or sixty seconds), when a particular value is detected by a filter, before and/or after an input is received and/or an output is produced, when an error is detected, and/or upon the occurrence of any other defined event.

The persistence information can be any type of information and may include data that is being processed. For example, persistence information may include values associated with particular variables of a block. From the perspective of the storing block 232, the persistence information may be stored directly to a persistence storage 1408 or may be stored via an intermediary, such as the persistence module 448 of FIG. 4B. The persistence storage 1408 can be any type of storage and may store information in one or more files. The persistence module 448 may handle the saving and retrieving of information in many different ways depending on its configuration and the format of the persistence storage 1408. For example, the persistence module 448 may use a unique file for each block 232 or may use a single file for multiple blocks 232.

In step 1404, the saved persistence information may be retrieved. Depending on the particular configuration, the retrieval may be directly from the persistence storage 1408 or may use the persistence module 448. The act of retrieval can be triggered in various ways, such as by the receipt of a load command, when the block 232 is started (e.g., retrieve any persistence information when started), the expiration of a timer, when a particular value is detected by a filter, before and/or after an input is received and/or an output is produced, when an error is detected, and/or upon the occurrence of any other defined event.

In step 1406, the retrieved persistence information can then be loaded. For example, the persistence information can loaded as values for the appropriate variables of the block 232. The loading may occur while the NIO platform 602 is running (e.g., save and load as part of the operation of the block 232) and/or after the core 406, a core component 412, a module 404, a service 230, or a block 232 has been restarted. For example, after the block 232 is restarted, it may recover and load state information and/or other information for continued operation from a previous state. It is understood that the retrieving of step 1404 and the loading of step 1406 may be performed in a single command that assigns values that are retrieved as part of the command's argument.

It is noted that references to the storage of persistence information in the present example are generally referring to state information, and not to the storage of all information that passes through a block 232. For example, if a block 232 is to store all incoming data in a database, the persistence module 448 would generally not be used for this storage process. Instead, a block 232 specifically designed for database inserts may be used by the service 230 as a more desirable mechanism to achieve such database storage. However, as the persistence module 448 can be used to insert data into a database and the information to be saved by a particular block 232 can be configured as desired, the persistence module 448 can be used for inserting some or all data that is received, processed, and/or output by the block 232 into a database or other storage.

Referring to FIG. 15, a sequence diagram 1500 illustrates another embodiment of a process that may be used to provide information persistence within a NIO platform (e.g., the NIO platform 602 of FIG. 6). In the present example, the persistence storage 1408/persistence module 448 is used by a block 232 indirectly through a service 230 that is running the block. For example, the block 232 may make a call to save information to persistence storage. The call may be caught and handled by the service 230 in the same basic manner that the service 230 catches calls to process output from the block 232 using notifySignals(). Alternatively, the block 232 may make a call to the persistence module 448, and the service 230 may catch and handle the call.

Accordingly, in step 1502, the block 232 requests that information be stored or loaded. In step 1504, the service 230 handles the request and either saves the information to the persistent storage 1408 (directly or via the persistence module 448) or retrieves information from the persistent storage 1408 (directly or via the persistence module 448). In step 1506, the service 230 responds to the request and returns the information to the block 232 if the request was for loading information or, if a save request was received, the service may acknowledge the request and/or inform the block 232 that the information has been saved. In step 1508, if the block 232 retrieved information, the block 232 loads the information for use.

Referring to FIG. 16, a sequence diagram 1600 illustrates another embodiment of a process that may be used to provide information persistence within a NIO platform (e.g., the NIO platform 602 of FIG. 6). In the present example, the previously described persistence module 448 is used to store and retrieve information for a block 232 and the block 232 communicates directly with the persistence module 448.

It is noted that, while the block 232 or other component of the NIO platform 602 may be configured to write information directly to the persistence storage 1408 and retrieve information directly from the persistence storage 1408 as described with respect to FIGS. 14 and 15, this does not mean they can access the saved information after restart. In other words, the block 232 may be able to directly write to and read from the persistence storage 1408 during the current instantiation of the block 232, but directly accessing the same persistence storage 1408 after a restart would require that the block 232 know the location of the persistence storage 1408.

Accordingly, for the block 232 to be able to recover information directly from the persistence storage 1408 after a restart, such location knowledge would have to be available to the block 232. While embodiments of the NIO platform may be implemented to pass the location information to the block 232 after the block 232 is restarted (e.g., from the core 406 to the service 230 via the SIC, and from the service 230 to the block 232 via the BIC), the current embodiment of the NIO platform 602 provides an alternate solution using the persistence module 448.

As previously described, the NIO platform 602 may use modules to provide additional functionality across an entire NIO platform instance. Accordingly, the persistence module 448 provides at least two advantages to the NIO platform 602. First, the persistence module 448 can be modified to change how the persistence itself is accomplished without having to make changes to service or block structures. As previously described, a module can be modified and that modification affects the functionality of the module across the entire NIO platform instance. Second, the persistence module 448 can be used to store persistence information in a consistent manner regardless of the particular block 232 that needs such functionality and, therefore, the information can be consistently retrieved even after a restart occurs. This enables the block 202 and other components of the NIO platform 602 to incorporate the persistence storage functionality of the persistence module 448 in a standardized manner with minimal user effort.

Continuing with the example of FIG. 16, the service 230 loads the persistence module 448 as part of the service process and then configures the persistence module 448 for use by blocks 232 within the service 230. Accordingly, in steps 1602 and 1604, the service 230 configures the persistence module 448 and the block 232, respectively. In step 1606, the block 232 can then communicate directly with the persistence module 448 to store and/or retrieve persistence information. If information is retrieved in step 1606, the information is loaded by the block 232 in step 1608.

Referring to FIG. 17, a sequence diagram 1700 illustrates another embodiment of a process that may be used to provide information persistence within a NIO platform (e.g., the NIO platform 602 of FIG. 6). In the present example, the persistence module 448 is used to store and retrieve information for a block 232, and the block 232 interacts indirectly with the persistence module 448. Accordingly, in steps 1702 and 1704, the service 230 configures the persistence module 448 and block 232, respectively. In step 1706, the block 232 requests from the service 230 that persistence information be stored or retrieved. In step 1708, the service 230 communicates with the persistence module 448 to handle the request. In step 1710, the service 230 returns the information to the block 232 or, if a save request was received, may acknowledge the request and/or inform the block 232 that the information has been saved. In step 1712, the block 232 loads the information for use if step 1710 returned retrieved information.

Referring to FIG. 18, a sequence diagram 1800 illustrates another embodiment of a process that may be used to provide information persistence within a NIO platform (e.g., the NIO platform 602 of FIG. 6). In the present example, the persistence module 448 is used to store and retrieve information for a block 232 and the block 232 communicates directly with the persistence module 448.

In step 1802, the core 406 creates a SIC for the service 230. As previously described, this occurs after the persistence module 448 has been discovered and initialized. Accordingly, the SIC contains information about the persistence module 448 that is needed by the service 230. In step 1804, the core 406 sends the SIC to the service 230 for configuration. In step 1806, the service 230 loads the persistence module 448 and configures the persistence module 448 for use. The configuration may include the service 230 assigning an identifier to the persistence module 448 and/or setting various parameters. For example, the service 230 may assign the name of the service itself as the identifier for the persistence module 448.

In step 1808, the persistence module 448 attempts to locate an existing persistence file using the assigned name or another identifier. If a persistence file currently exists, there is generally no need to create one. If no existing persistence file is located, the persistence module 448 may create a persistence file. In other embodiments, the persistence module 448 may wait until it receives information to be saved before creating a persistence file.

In steps 1810 and 1812, respectively, the service 230 creates a BIC for the block 232 and sends the BIC to the block 232. The BIC may contain information identifying the persistence module 448, any values to be persisted by the block 232, and similar information. It is understood that one or both of steps 1810 and 1812 may occur before or simultaneously with steps 1806 and/or 1808.

In step 1814, the block 232 checks with the persistence module 448 for any persistence information that the persistence module 448 may have for the block 232. It is noted that this initial request may not be repeated since the purpose is to determine if there is any persistence information following block startup. In step 1816, the persistence module 448 returns any information it may have for the block 232. In step 1818, the block 232 loads any information received. Following one or more of steps 1814, 1816, and 1818 (depending on whether there is stored persistence information to be loaded), the block 232 may use the persistence module 448 to save and retrieve persistence information as described below with respect to FIGS. 19 and 20.

In the present example, each service 230 of the NIO platform 602 includes the persistence module 448. Furthermore, each block 232 has the instructions needed to communicate with the persistence module 448 to save and load information, even if the functionality is not used. Accordingly, steps 1814, 1816, and 1818 may only be performed at startup for blocks configured to use the persistence module 448. Other blocks would receive the information about the persistence module 448 in step 1812, but would not use it.

It is understood that other embodiments may not force this functionality on all services and/or blocks. In such embodiments, based on the particular configuration of the service 230 and its blocks 232, one or both of steps 1802 and 1810 may not even include the information about the persistence module 448 in the context being created. In some embodiments, the base block class may include instructions needed to create a persistence object that includes the calls needed to use the persistence module 448. In other embodiments, the base block class may contain no such instructions, and users may have to specifically add instructions to each block for which persistence functionality is desired (e.g., via a mixin or other otherwise).

Referring to FIG. 19, a sequence diagram 1900 illustrates another embodiment of a process that may occur following step 1818 of FIG. 18 to provide information persistence within the NIO platform 602. In the present example, the persistence module 448 is used to store information for the block 232. It is understood that the persistence module 448 may handle the saving and retrieving of information in many different ways. For example, the persistence module 448 may use a unique persistence file 1408 for each block 232 or may use a single persistence file 1408 for multiple blocks 232 with information for each block distinguished within the persistence file from information for other blocks. For purposes of illustration, the persistence module 448 uses a single persistence file based on key/value pairs. Each key is an identifier for a particular block within the service 230 (e.g., the block's name) and is associated with a corresponding value or set of values representing the block's data within the persistence file 1408.

Accordingly, in step 1902, the block 232 sends information to be stored to the persistence module 448 using the key/value pairing described previously. For example, the block 232 may send a niogram with block name and dictionary as the name/value pair, where the dictionary contains variables and corresponding values at the time the save is performed. In step 1904, the persistence module 448 saves this information to the persistence file 1408.

Referring to FIG. 20, a sequence diagram 2000 illustrates another embodiment of a process that may occur following step 1818 of FIG. 18 to provide information persistence within the NIO platform 602. In the present example, the persistence module 448 is used to retrieve information for the block 232. Accordingly, in step 2002, the block 232 requests stored information from the persistence module 448 using the key/value pairing described previously. In steps 2004 and 2006, respectively, the persistence module 448 retrieves this information from the persistence file 1408 and returns it to the block 232. In step 2008, the block 232 loads the information.

In some embodiments, the persistence module 448 may prefetch persistence information (e.g., in step 1808 of FIG. 18) and it is understood that step 2004 would occur before step 2002 in such embodiments. For example, the persistence module 448 may load all existing persistence information into memory following the persistence module's configuration, and this information would then be available for retrieval by a block without the persistence module 448 having to access the persistence file 1408 following the block's request.

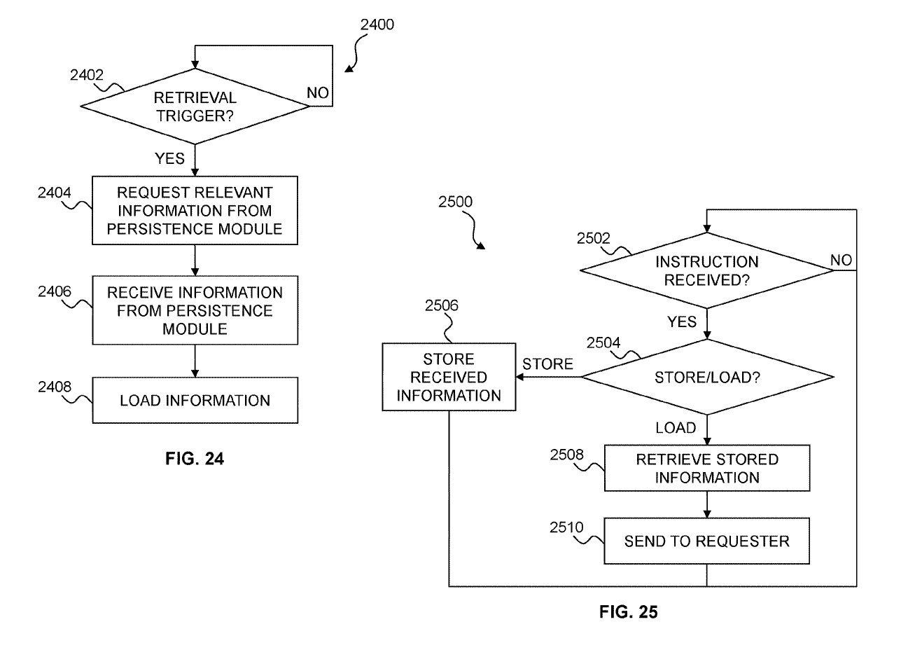

Referring to FIG. 21, a method 2100 illustrates one embodiment of a process that may be executed to configure a block 232 to save persistence information. In step 2102, the block 232 is configured to save information as desired. For example, the block 232 may be configured to use the persistence module 448 and to save a defined set of variable values upon the occurrence of one or more defined events. In step 2104, the configured block 232 is saved. When run by the NIO platform 602, the block 232 will persist the information using the persistence module 448 based on the block's configuration.

Referring to FIG. 22, a method 2200 illustrates one embodiment of a process that may be executed by a block 232 within the NIO platform 602 when the block is started. In step 2202, the block 232 is configured using the BIC provided by the service 230. In step 2204, the block 232 requests any information that the persistence module 448 may have for the block. In step 2206, based on whether information was received in response to the request in step 2204, the method 2200 moves to either step 2208 or 2210. If information was received, the block 232 loads the information for use in step 2208 and is then ready for operation in step 2210. If no information was received, the method 2200 moves directly to step 2210.

Referring to FIG. 23, a method 2300 illustrates one embodiment of a process that may be executed by a block 232 within the NIO platform 602 when the block is running (e.g., after the method 2200 of FIG. 22 is executed). In step 2302, a determination is made as to whether a storage trigger has occurred. If no storage trigger has occurred, the method 2300 repeats step 2302 until a storage trigger occurs or the block 232 is stopped. If a storage trigger has occurred, the method 2300 continues to step 2304, where information is sent to the persistence module 448 for storage. For example, the block 232 may send one or more key/value pairs for storage.

Referring to FIG. 24, a method 2400 illustrates one embodiment of a process that may be executed by a block 232 within the NIO platform 602 when the block is running (e.g., after the method 2200 of FIG. 22 is executed). In step 2402, a determination is made as to whether a retrieval trigger has occurred. If no retrieval trigger has occurred, the method 2400 repeats step 2402 until a retrieval trigger occurs or the block 232 is stopped. If a retrieval trigger has occurred, the method 2400 continues to step 2404, where the block 232 requests information from the persistence module 448. It is understood that the request may be for all saved information or for only certain portions of the saved information. In step 2406, the information is received from the persistence module. In step 2408, the received information is loaded for use by the block 232.

Referring to FIG. 25, a method 2500 illustrates one embodiment of a process that may be executed by the persistence module 448 within the NIO platform 602. In step 2502, a determination is made as to whether an instruction has been received. If no instruction has been received, the method 2500 repeats step 2502 until an instruction is received or the persistence module 448 is stopped. If an instruction has been received (as determined in step 2502) and the instruction is a store instruction (as determined in step 2504), the method 2500 moves to step 2506, where the information is stored in the persistence file 1408 (or other storage, such as a database). The method 2500 then returns to step 2502.

If an instruction has been received (as determined in step 2502) and the instruction is a load instruction (as determined in step 2504), the method 2500 moves to step 2508, where the information is retrieved from the persistence file 1408 (or other storage, such as a database). In step 2510, the retrieved information is sent to the requestor, whether a block 232 or another component of the NIO platform 602. The method 2500 then returns to step 2502. In some embodiments, the persistence module 448 may prefetch persistence information (e.g., in step 1808 of FIG. 18) and it is understood that step 2508 would occur before step 2504 and/or step 2502 in such embodiments.

While the preceding description shows and describes one or more embodiments, it will be understood by those skilled in the art that various changes in form and detail may be made therein without departing from the spirit and scope of the present disclosure. For example, various steps illustrated within a particular flow chart may be combined or further divided. In addition, steps described in one diagram or flow chart may be incorporated into another diagram or flow chart. Furthermore, the described functionality may be provided by hardware and/or software, and may be distributed or combined into a single platform. Additionally, functionality described in a particular example may be achieved in a manner different than that illustrated, but is still encompassed within the present disclosure. Therefore, the claims should be interpreted in a broad manner, consistent with the present disclosure.

For example, in one embodiment, a method for providing persistence in a configurable platform instance includes configuring a service of the configurable platform instance to run a plurality of blocks, wherein each block of the plurality of blocks includes a set of platform specific instructions that enable the block to operate within the configurable platform instance and a set of task specific instructions that enable the block to perform a specific task for the service; configuring a persistence module of the platform instance for use by the service; configuring at least one of the plurality of blocks for interaction with the persistence module, wherein the interaction enables the block to use the persistence module to store persistence information for the block and to load previously stored persistence information for the block; and running the service, the persistence module, and the blocks.

In some embodiments, configuring the persistence module includes determining whether at least one persistence file exists for the service; and creating the persistence file if the persistence file does not exist.

In some embodiments, creating the persistence file is performed by the persistence module.

In some embodiments, creating the persistence file is performed by the service.

In some embodiments, the service has a unique service name within the platform configurable instance, and wherein configuring the persistence module further includes setting a name of the persistence module as the service name.

In some embodiments, each of the plurality of blocks includes functionality required for interaction with the persistence module, and wherein usage of the persistence module by each of the blocks is based on configuration information corresponding to the block.

In some embodiments, the persistence module uses a separate persistence file for each of the blocks that are configured to save information through the persistence module.

In some embodiments, the persistence module uses a single persistence file for all of the blocks that are configured to save information through the persistence module.

In some embodiments, configuring the block includes creating a persistence object for the block, wherein the persistence object serves as an interface between the block and the persistence module.

In some embodiments, the block interacts directly with the persistence module.

In some embodiments, the block interacts indirectly with the persistence module by using the service as an intermediary.

In some embodiments, the method further includes storing, by the block, persistence information using the persistence module.

In some embodiments, the method further includes: obtaining, by the block, persistence information using the persistence module; and loading, by the block, the persistence information.

In some embodiments, the method further includes determining, after the block is stopped and restarted, whether the persistence module has any persistence information for the block.

In some embodiments, the persistence information is state information.

In another embodiment, a method includes configuring at least one of a plurality of blocks to store persistence information in a persistence storage, wherein the plurality of blocks are to be run by a service of a configurable platform, wherein each block of the plurality of blocks includes a set of platform specific instructions that enable the block to operate within the configurable platform and a set of task specific instructions that enable the block to perform a specific task for the service, and wherein configuring the block includes defining at least one variable of the block to be saved in the persistence storage; defining at least one trigger to indicate when the variable is to be saved; and saving the variable and the trigger for use by the block when the block is run by the service.

In some embodiments, the method further includes: running the block; detecting that the trigger has occurred; and storing a value corresponding to the variable in the persistence storage.

In some embodiments, the method further includes: running the block; retrieving a value corresponding to the variable from the persistence storage; and loading the value for use by the block.

In some embodiments, the block is configured to use a persistence module to store the persistence information in the persistence storage.

In some embodiments, the method further includes: running the block; detecting that the trigger has occurred; and sending a value corresponding to the variable to the persistence module for storage by the persistence module.

In some embodiments, the method further includes: running the block; requesting that the persistence module retrieve a value corresponding to the variable from the persistence storage; sending the value to the block; and loading the value in the block.

In another embodiment, a configurable platform includes a core configured to interact with an operating system on a device; at least a first service that is configured to be run by the core; and a plurality of blocks that are configured to be run by the first service, wherein each block of the plurality of blocks is configured to operate independently from the other blocks and includes a set of platform specific instructions that enable the block to operate within the configurable platform and a set of task specific instructions that enable the block to perform a specific task, and wherein at least one of the plurality of blocks is configured to use a persistence module of the configurable platform to store persistence information for the block and to load any previously stored persistence information for the block.

In another embodiment, a system includes a processor; and a memory coupled to the processor and containing instructions for execution by the processor, the instructions for: configuring a service of the configurable platform instance to run a plurality of blocks, wherein each block of the plurality of blocks includes a set of platform specific instructions that enable the block to operate within the configurable platform instance and a set of task specific instructions that enable the block to perform a specific task for the service; configuring a persistence module of the platform instance for use by the service;

configuring at least one of the plurality of blocks for interaction with the persistence module, wherein the interaction enables the block to use the persistence module to store persistence information for the block and to load previously stored persistence information for the block; and running the service, the persistence module, and the blocks.

In some embodiments, the instructions for configuring the persistence module include: determining whether at least one persistence file exists for the service; and creating the persistence file if the persistence file does not exist.

In some embodiments, creating the persistence file is performed by the persistence module.

In some embodiments, creating the persistence file is performed by the service.

In some embodiments, the service has a unique service name within the platform configurable instance, and wherein configuring the persistence module further includes setting a name of the persistence module as the service name.

In some embodiments, each of the plurality of blocks includes functionality required for interaction with the persistence module, and wherein usage of the persistence module by each of the blocks is based on configuration information corresponding to the block.

In some embodiments, the persistence module uses a separate persistence file for each of the blocks that are configured to save information through the persistence module.

In some embodiments, the persistence module uses a single persistence file for all of the blocks that are configured to save information through the persistence module.

In some embodiments, the instructions for configuring the block include creating a persistence object for the block, wherein the persistence object serves as an interface between the block and the persistence module.

In some embodiments, the block interacts directly with the persistence module.

In some embodiments, the block interacts indirectly with the persistence module by using the service as an intermediary.

In some embodiments, the instructions further include storing, by the block, persistence information using the persistence module.

In some embodiments, the instructions further include: obtaining, by the block, persistence information using the persistence module; and loading, by the block, the persistence information.

In some embodiments, the instructions further include determining, after the block is stopped and restarted, whether the persistence module has any persistence information for the block.

In some embodiments, the persistence information is state information.

In another embodiment, a system includes a processor; and a memory coupled to the processor and containing instructions for execution by the processor, the instructions for: configuring at least one of a plurality of blocks to store persistence information in a persistence storage, wherein the plurality of blocks are to be run by a service of a configurable platform, wherein each block of the plurality of blocks includes a set of platform specific instructions that enable the block to operate within the configurable platform and a set of task specific instructions that enable the block to perform a specific task for the service, and wherein configuring the block includes defining at least one variable of the block to be saved in the persistence storage; defining at least one trigger to indicate when the variable is to be saved; and saving the variable and the trigger for use by the block when the block is run by the service.

In some embodiments, the instructions further include: running the block; detecting that the trigger has occurred; and storing a value corresponding to the variable in the persistence storage.

In some embodiments, the instructions further include: running the block; retrieving a value corresponding to the variable from the persistence storage; and loading the value for use by the block.

In some embodiments, the block is configured to use a persistence module to store the persistence information in the persistence storage.

In some embodiments, the instructions further include: running the block; detecting that the trigger has occurred; and sending a value corresponding to the variable to the persistence module for storage by the persistence module.

In some embodiments, the instructions further include: running the block; requesting that the persistence module retrieve a value corresponding to the variable from the persistence storage; sending the value to the block; and loading the value in the block.

In another embodiment, a system includes a processor; and a memory coupled to the processor and containing instructions for execution by the processor, the instructions for providing a configurable platform having a core configured to interact with an operating system; at least a first service that is configured to be run by the core; and a plurality of blocks that are configured to be run by the first service, wherein each block of the plurality of blocks is configured to operate independently from the other blocks and includes a set of platform specific instructions that enable the block to operate within the configurable platform and a set of task specific instructions that enable the block to perform a specific task, and wherein at least one of the plurality of blocks is configured to use a persistence module of the configurable platform to store persistence information for the block and to load any previously stored persistence information for the block.

What is claimed is:

1. A method for providing persistence in a configurable platform instance, the method comprising:
configuring a service of the configurable platform instance to run a plurality of blocks, wherein each block of the plurality of blocks includes a set of platform specific instructions that enable the block to operate within the configurable platform instance and a set of task specific instructions that enable the block to perform a specific task for the service;
configuring a persistence module of the platform instance for use by the service;
configuring at least one of the plurality of blocks for interaction with the persistence module, wherein the interaction enables the block to use the persistence module to store persistence information for the block and to load previously stored persistence information for the block; and
running the service, the persistence module, and the blocks.

2. The method of claim 1 wherein configuring the persistence module includes:
determining whether at least one persistence file exists for the service; and
creating the persistence file if the persistence file does not exist.

3. The method of claim 2 wherein creating the persistence file is performed by the persistence module.

4. The method of claim 2 wherein creating the persistence file is performed by the service.

5. The method of claim 2 wherein the service has a unique service name within the platform configurable instance, and wherein configuring the persistence module further includes setting a name of the persistence module as the service name.

6. The method of claim 1 wherein each of the plurality of blocks includes functionality required for interaction with the persistence module, and wherein usage of the persistence module by each of the blocks is based on configuration information corresponding to the block.

7. The method of claim 1 wherein the persistence module uses a separate persistence file for each of the blocks that are configured to save information through the persistence module.

8. The method of claim 1 wherein the persistence module uses a single persistence file for all of the blocks that are configured to save information through the persistence module.

9. The method of claim 1 wherein configuring the block includes creating a persistence object for the block, wherein the persistence object serves as an interface between the block and the persistence module.

10. The method of claim 1 wherein the block interacts directly with the persistence module.

11. The method of claim 1 wherein the block interacts indirectly with the persistence module by using the service as an intermediary.

12. The method of claim 1 further comprising storing, by the block, persistence information using the persistence module.

13. The method of claim 1 further comprising:
obtaining, by the block, persistence information using the persistence module; and
loading, by the block, the persistence information.

14. The method of claim 14 further comprising determining, after the block is stopped and restarted, whether the persistence module has any persistence information for the block.

15. The method of claim 1 wherein the persistence information is state information.

16. A system comprising:
a processor; and
a memory coupled to the processor and containing instructions for execution by the processor, the instructions for:
configuring at least one of a plurality of blocks to store persistence information in a persistence storage, wherein the plurality of blocks are to be run by a service of a configurable platform, wherein each block of the plurality of blocks includes a set of platform specific instructions that enable the block to operate within the configurable platform and a set of task specific instructions that enable the block to perform a specific task for the service, and wherein configuring the block includes
defining at least one variable of the block to be saved in the persistence storage;
defining at least one trigger to indicate when the variable is to be saved; and
saving the variable and the trigger for use by the block when the block is run by the service.

17. The system of claim 16 wherein the instructions further include:
running the block;
detecting that the trigger has occurred; and
storing a value corresponding to the variable in the persistence storage.

18. The system of claim 16 wherein the instructions further include:
running the block;
retrieving a value corresponding to the variable from the persistence storage; and
loading the value for use by the block.

19. The method of claim 16 wherein the block is configured to use a persistence module to store the persistence information in the persistence storage.

20. The system of claim 19 wherein the instructions further include:
running the block;
detecting that the trigger has occurred; and
sending a value corresponding to the variable to the persistence module for storage by the persistence module.
